(19) United States
(12) Patent Application Publication
(10) Pub. No.: US 2015/0120493 A1
(43) Pub. Date: Apr. 30, 2015

(54) GUIDED AND INTERACTIVE RECOMMENDATION SYSTEM AND METHOD

(71) Applicants: Vamshi Mokshagundam, Doddanekkundi (IN); Ayan Barua, Baranagar (IN)

(72) Inventors: Vamshi Mokshagundam, Doddanekkundi (IN); Ayan Barua, Baranagar (IN)

(73) Assignee: CE140, INC., Dallas, TX (US)

(21) Appl. No.: 14/509,056

(22) Filed: Oct. 8, 2014

Related U.S. Application Data
(60) Provisional application No. 61/887,993, filed on Oct. 8, 2013.

(51) Int. Cl. G06Q 30/06

(52) U.S. Cl. CPC G06Q 30/0631
USPC 705/26.7

(57) ABSTRACT

A guided and interactive recommendation system and method. In-depth product and service profiles are stored followed by a user profile of a user that wishes to employ the system and method. An initial ranking of products and services is performed based upon other information, and parameters inherited from the user profile. A real-time queue—and blocks for insertion into the real-time queue are generated. Questions in the blocks that meet eligibility conditions are traversed sequentially until all of the blocks and questions therein are traversed. Products and services rankings are computed and recomputed along with the questions until all of the questions and blocks are exhausted.

### CLAIM OF PRIORITY

The present invention claims priority from Provisional U.S. Patent Application No. 61/887,993, entitled “Recommendation System and Method” filed Oct. 8, 2014, which is hereby incorporated by reference as if fully set forth in the present specification.

### BACKGROUND OF THE INVENTION

The present invention relates generally to computer information and communication systems and methods and more specifically to computer information and communication systems and methods for recommending to users one or more products, services and the like.

A typical user that is seeking a product, service, solution or the like may employ one of the widely available search engines to initiate an online search. As an example, an enterprise user may be seeking a software solution that is compatible with the enterprise platform. Depending on the need and search terms used, it might take the user several hours or even days to compile a list of desirable products or services.

After a list is compiled, the user often begins with the first product or service on the list and proceeds to conduct detailed research to determine whether that product or service is suitable for the user or the user's firm's needs. If not, the user proceeds to the next product or service on the list and thereafter, the subsequent product until the products or services on the list are exhausted. Note that in order to conduct high-quality research, the user must know the right questions to ask and must understand the features and attributes of the products or services being researched.

Eventually, after the research is conducted, a product or service that the user deems suitable is then selected for implementation. Months or years after implementation, the user might discover that the selected product or service is inadequate or unsuitable for the user's needs. The user is then faced with a conundrum: either to keep using an inadequate product or service or uninstall the product or service to find a replacement product or service, resulting in loss of valuable resources including money and time.

Alternatively, rather than conducting an online search, the user can utilize consultants to find the desired product or service. After analyzing the user's needs, such consultants often recommend a suitable product or service. Unlike an online search, the user often compensates the consultants for their services, and such compensation might easily cost the user thousands or tens of thousands of dollars.

It is within the aforementioned context that a need for the present invention has arisen. Thus, there is a need to address one or more of the foregoing disadvantages of conventional systems and methods, and the present invention meets this need.

### BRIEF SUMMARY OF THE INVENTION

Various aspects of a guided and interactive recommendation system and method for selecting products, services and the like can be found in exemplary embodiments of the present invention.

In a first embodiment, an enterprise user, for example, seeking an appropriate platform product or service may utilize embodiments of the present invention. Specifically, an embodiment of the present invention employs one or more computing systems to store in a database in-depth features and attributes for a multiplicity of products and services. Products and services including technical features, security capabilities and the like are thoroughly researched and in some instances, categories for the researched products and services are created and stored in said database.

The enterprise user may utilize a spurned wizard interface to indicate a type of product or service that is desired. In turn, an initial ranking of the products and services is computed for display to the user where this initial ranking is based at least in part on a vector having at least two dimensions. Such dimensions may include product capability functionality and social sentiment for example. The initial ranking may also be dependent on information inherited from the user profile as well as product and service profiles.

An embodiment of the system and method of the present invention thereafter generates a real-time queue configured to receive one or more blocks where each block includes related, plural questions for display to the user. Aggregating related questions into blocks avoids the need to set multiple flags and avoids redundant or irrelevant questions.

The initial block to be generated and moved into the real-time queue is determined. In one aspect, this determination may be based on a flag that sets a condition for moving the initial block into the queue. Note that although questions are disposed within the blocks, they may or may not be displayed to the user, such display depending on the question eligibility.

The computing system traverses the initial block to determine whether all of the questions ought to be displayed. After traversing the first block, the system proceeds to additional blocks, if any, within the queue. Appropriate eligible responses selectable by the user are also displayed for questions that meet the eligibility requirements.

In this manner, the recommendation system and method of the present invention employs a guided interface and interactive interface with sequential question and response flow providing the user with guided technical questions, for example, that the user might otherwise not have and permitting high-quality selection of features and attributes that are relevant and compatible with the user's platform needs.

Each flow is unique for most users and might depend upon the user's industry role. Different user experiences are created for different users. A user with complex needs creates a complex flow with additional questions being added to the user's experience. Selecting a particular response may add additional questions, blocks, flags, products and services after which reranking of the products and services for recommendation is performed.

A further understanding of the nature and advantages of the present invention herein may be realized by reference to the remaining portions of the specification and the attached drawings. Further features and advantages of the present invention as well as the structure and operation of various embodiments of the present invention are described in detail below with respect to the accompanying drawings. In the drawings, the same reference numbers indicate identical or functionally similar elements.

### BRIEF DESCRIPTION OF THE DRAWINGS

FIG. 1 illustrates a guided and interactive recommendation system according to an exemplary embodiment of the present invention.

FIG. 2 illustrates a screenshot of a recommendation landing page hosted by the recommendation server system of FIG. 1 and user selection of a product or service need according to an exemplary embodiment of the present invention.

FIG. 3 is a social advertising interface screenshot illustrating an initial question and an initial ranking of products and services for a social advertising campaign according to an exemplary embodiment of the present invention.

FIG. 4 is a social advertising interface screenshot illustrating a subsequent question and reranking of the social advertising products and services according to an exemplary embodiment of the present invention.

FIG. 5 is a social advertising interface screenshot illustrating a follow-up question to the “Yes” response of FIG. 4 and reranking of the social advertising products and services according to an exemplary embodiment of the present invention.

FIG. 6 is a social advertising interface screenshot illustrating a follow-up question to the “No” response of FIG. 4 and reranking of the social advertising products and services according to an exemplary embodiment of the present invention.

FIG. 7 is a social advertising interface screenshot illustrating a follow-up question when all response options of FIG. 5 are selected and also shows reranking of the social advertising products and services according to an exemplary embodiment of the present invention.

FIG. 8 is a social advertising interface screenshot illustrating a follow-up question based upon a Twitter response option selected in FIG. 5 and reranking of the social advertising products and services according to an exemplary embodiment of the present invention.

FIG. 9 is a social advertising interface screenshot illustrating a follow-up question based upon a “No” response option selected in FIG. 8 and reranking of the social advertising products and services according to an exemplary embodiment of the present invention.

FIG. 10 is a social advertising interface screenshot illustrating a follow-up question based upon the “Fixed monthly fee” response option selected in FIG. 9 and reranking of the social advertising products and services according to an exemplary embodiment of the present invention.

FIG. 11 is a social advertising interface screenshot illustrating a follow-up question based upon the “No” response option of FIG. 10 and reranking of the social advertising products and services according to an exemplary embodiment of the present invention.

FIG. 12 is a social advertising interface screenshot illustrating a follow-up question based upon all response options selected in FIG. 11 and reranking of the social advertising products and services according to an exemplary embodiment of the present invention.

FIG. 13 is a social advertising interface screenshot illustrating a follow-up question based upon a “Yes” response option selected in FIG. 12 and reranking of the social advertising products and services according to an exemplary embodiment of the present invention.

FIG. 14 is a social advertising interface screenshot illustrating a follow-up question based upon selecting all responses in FIG. 13 and reranking of the social advertising products and services according to an exemplary embodiment of the present invention.

FIG. 15 is a social advertising interface screenshot illustrating a follow-up question based upon a “Yes” response option selected in FIG. 14 and reranking of the social advertising products and services according to an exemplary embodiment of the present invention.

FIG. 16 is a social advertising interface screenshot illustrating a follow-up question based upon selecting “Cost per install . . . ” and “Cost per fan . . . ” response options in FIG. 15 and reranking of the social advertising products and services according to an exemplary embodiment of the present invention.

FIG. 17 is a social advertising interface screenshot illustrating a follow-up question based upon selecting “between 11 and 50” in FIG. 16 and reranking of the social advertising products and services according to an exemplary embodiment of the present invention.

FIG. 18 is a social advertising interface screenshot illustrating a follow-up question based upon a “Traditional ad . . . ” and “FaceBook page . . . ” response options selected in FIG. 17 and reranking of the social advertising products and services according to an exemplary embodiment of the present invention.

FIG. 19 is a social advertising interface screenshot illustrating a follow-up question based upon a “Very important” response option selected in FIG. 18 and reranking of the social advertising products and services according to an exemplary embodiment of the present invention.

FIG. 20 is a social advertising interface screenshot illustrating a follow-up question based upon selecting “Click-path attribution” and “Bid optimization” responses in FIG. 18 and reranking of the social advertising products and services according to an exemplary embodiment of the present invention.

FIG. 20A illustrates a guide and interactive product/service recommendation method according to an exemplary embodiment of the present invention.

FIG. 21 illustrates system component architecture according to an exemplary embodiment of the present invention.

FIG. 22A illustrates containers and branches according to an exemplary embodiment of the present invention.

FIG. 22B illustrates a social media container structure according to an exemplary embodiment of the present invention.

FIG. 23 illustrates a trigger according to an exemplary embodiment of the present invention.

FIG. 24 illustrates condition flags according to an exemplary embodiment of the present invention.

FIG. 25 illustrates trigger actions according to an exemplary embodiment of the present invention.

FIG. 26 illustrates trigger actions according to an exemplary embodiment of the present invention.

FIG. 27 illustrates question parsing architecture actions according to an exemplary embodiment of the present invention.

FIG. 28 illustrates AppState progression according to an exemplary embodiment of the present invention.

FIG. 29 illustrates option eligibility according to an exemplary embodiment of the present invention.

FIG. 30 illustrates a product feature grid according to an exemplary embodiment of the present invention.

FIG. 31 illustrates capability mapping and scoring according to an exemplary embodiment of the present invention.

FIG. 32A illustrates a computer system usable with an embodiment of the present invention.

FIG. 32B shows subsystems of the computer of FIG. 32A according to an exemplary embodiment of the present invention.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail as to not unnecessarily obscure aspects of the present invention.

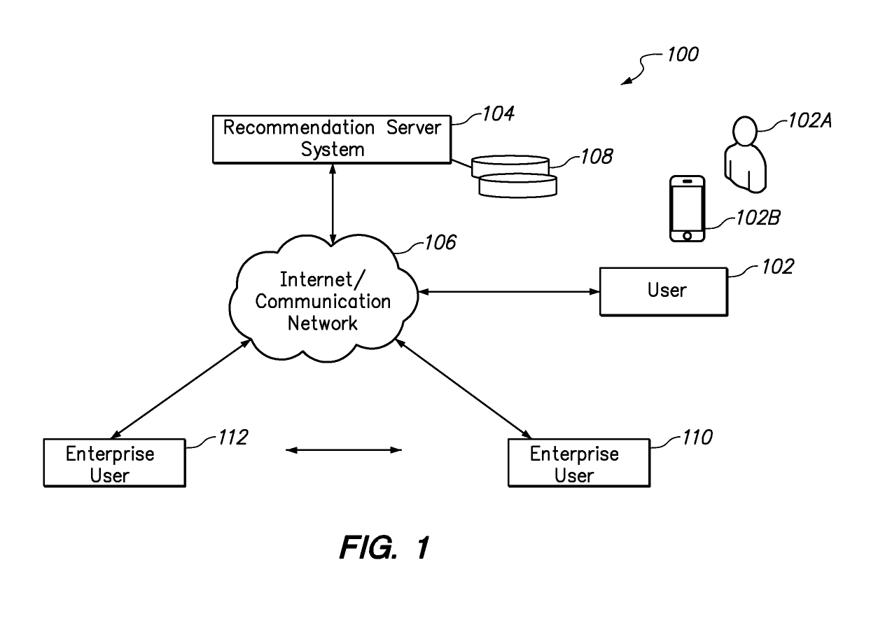

FIG. 1 illustrates guided and interactive recommendation system 100 according to an exemplary embodiment of the present invention.

Guided and interactive recommendation system 100 comprises recommendation server system 104 communicably coupled to user 102 via an Internet/communication network 106. Internet/communication network 106 is any communication network that allows point-to-point data transfer.

Here, user 102 might include an individual user 102A utilizing a mobile device 102B for example. User 102 might access recommendation server system 104 via Internet/communication network 106 to receive recommendations for products and services or other information or items. User 102 may also receive other information or recommended items such as solutions, frameworks, approaches, etc.

Although not shown, recommendation server system 104 may comprise a plurality of web and/or application servers. The servers may be based on any one of a plurality of software including Java, PHP, Cold Fusion, etc. Recommendation server system 104 is itself coupled to database 108 for storing user profiles as well as product and/or service information.

Guided and interactive recommendation system 100 further comprises enterprise user 110 also communicably coupled to recommendation server system 104 via Internet/communication network 106. Similarly, a second enterprise user 112 is also communicably coupled to recommendation server system 104 via Internet/communication network 106.

As can be seen, enterprise users 110 and 112 are part of the same organization or enterprise network. Enterprise user 112 can communicate with recommendation server system 104 while enterprise user 110 can also communicate with recommendation server system 104. Profile information applicable to the organization that is received from either enterprise user 110 or 112 is stored and applied to the organization profile.

Thus, if enterprise user 110 is in communication with recommendation server system 104, previously stored organization profiles generated based on communication with enterprise user 112 are used to enhance the organization profile. Recommendation server system 104 may also create individual profiles. Thus, individual profiles can be generated for enterprise users 110 and 112 as well as user 102. Here, user 102 might be an individual user such as a small business owner based in Dallas for example while enterprise users 112 and 110 may be employed by a large corporation.

As noted, recommendation server system 104 creates profiles based on current and previous interactions with the recommendation server system. These profiles include simple demographic information such as the user's role in an organization, the user's location, etc. The profile may also include information derived by an analytical model based on information stored in the profile.

For example, recommendation server system 104 may determine that a particular user is adept with social networks or that such a user is influential in purchasing decisions. Similar profiles are created for organizations by aggregating information from multiple users associated with that organization.

In use, user 102 (or enterprise user 110 or 112) can, in one embodiment, access recommendation server system 104 via a webpage hosted by said server system. Here, user 102 might wish to receive recommendations for products, services, solutions, frameworks, approaches or other such information or items consistent with the principle and scope of the present invention.

In turn, recommendation server system 104 can generate one or more question and answer recommendation interfaces that might include forms, etc., for collecting user requirements and preferences and for displaying system responses to preferences entered by user 102. In other embodiments, user 102 may access recommendation server system 104 via various recommendation tools built to address specific needs such as CRM (Customer Relationship Management) software or a payroll service provider.

Recommendation server system 104 includes a finite number of items grouped together in a container. Each container has a feature hierarchy of item capabilities and attributes defined. For example, a video conferencing recommendation may have technical capabilities such as support for HD (High Definition) video, screen sharing feature and VoIP (Voice Over Internet Protocol) in the hierarchy and solutions like GoToMeeting™, Skype™ and Cisco WebEx™ included in the container.

For all items in a given container, database 108 stores rating values or attribute values for each capability or attribute. For instance, Skype supports HD video, so it has a rating value of 10 (relative) for the HD video feature. Skype also supports a maximum value of 12 people in a single conference, so it has an attribute value of 12 for “maximum concurrent participants.”

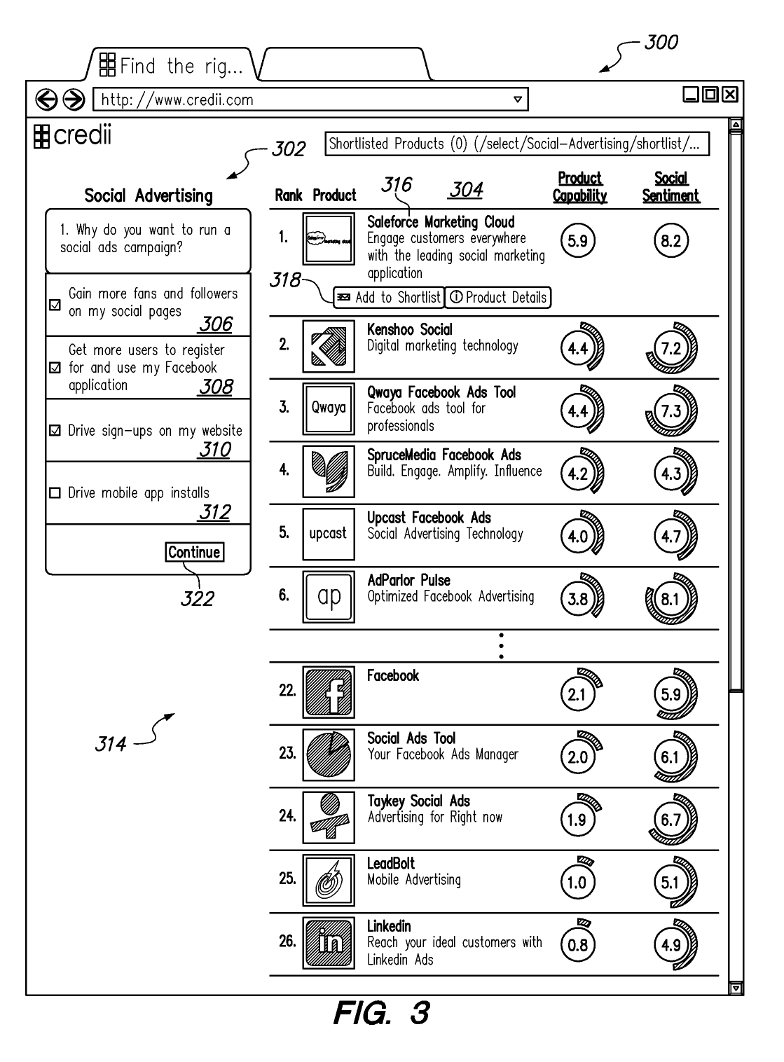

An example wherein user 102 is seeking social media advertising software will now be described with reference to FIGS. 3 through 20 below. One skilled in the art will realize that user 102 may also utilize the present invention to receive other items or information consistent with the spirit and scope of the present invention.

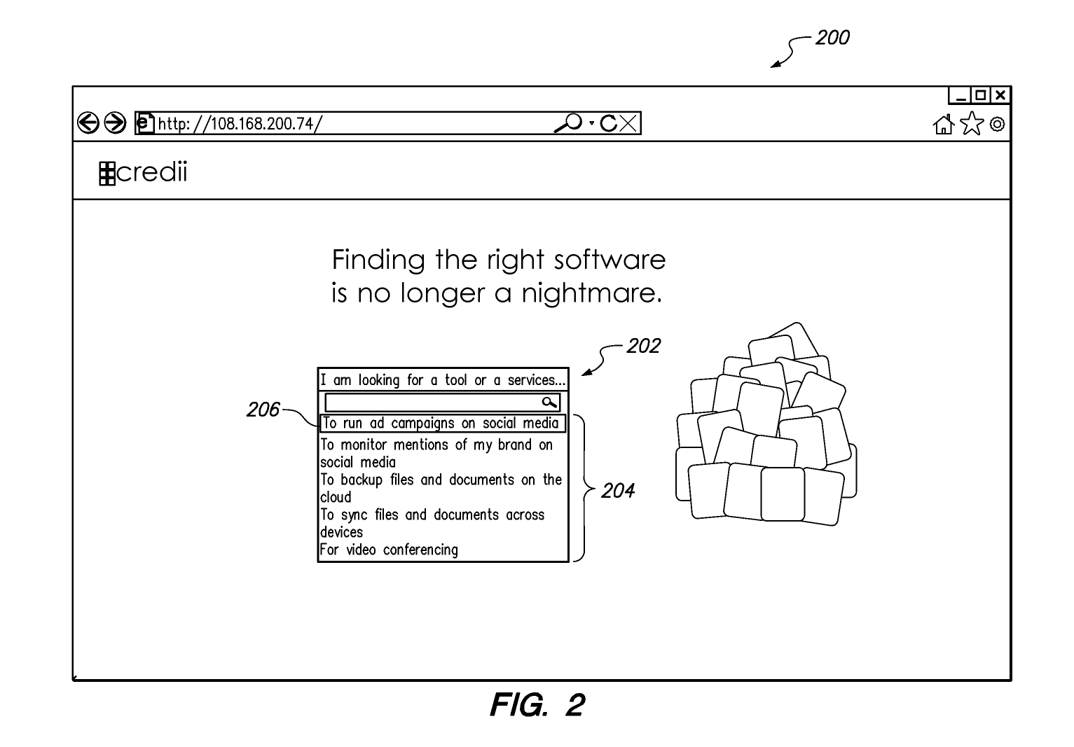

FIG. 2 illustrates a screen shot of recommendation landing page 200 hosted by recommendation server system 104 (FIG. 1) according to an exemplary embodiment of the present invention.

In FIG. 2, recommendation landing page 200 includes drop-down window 202 that generates options 204 from which user 102 can select a desired tool, product or service. The tool, product or service can then generate one or more recommendations for the user.

In this case, user 102 selects social advertising 206 “to run ad campaigns on social media,” which itself generates social advertising interface 300 of FIG. 3. Social advertising interface 300 comprises question area 302 as well as product and service listing area 304. Question area 302 displays a series of dynamically generated questions that allow recommendation server system 104 to understand users' needs, their preferences and their constraints.

The questions are based on what user 102 is looking for (for instance, social advertising software). The questions may also be based on user 102's profile. The questions may also be based on responses provided by user 102 to previous questions. As an example, if user 102 indicates a preference for monthly payments, further questions are then based on this response.

In the example of FIG. 3, Question 1: “Why do you want to run a social media ads campaign?” is displayed in question area 302. User 102, in turn, can select one or more of response 306 “Gain more fans and followers on my social pages,” response 308 “Get more users to register for and use my Facebook application,” response 310 “Drive sign-ups on my website,” or response 312 “Drive mobile app installs.” Once selected by user 102, the aforementioned responses are written back to database 108 (FIG. 1).

In FIG. 3, social advertising interface 300 also includes product and service listing area 304 located proximately and adjacent to question area 302. Here, product and service listing area 304 displays a shortlist of products 314 for responses selected by user 102 in question area 302. As can be seen in FIG. 3, a total of 26 products meeting the user's constraints is displayed.

Each product can be ranked based on one or more dimensions or attributes. As an example, each product may be ranked based on product capability. As implied by its name, a product capability rates the product functions and to what extent such functions are suitable for user 102.

As another example, a product or service may be ranked based on social sentiment. Social sentiment is a measure of how well a product is perceived by its users and customers. As a further example, a product may be ranked based on both product capability as well as social sentiment. Although not shown, products or services may be based on additional dimensions or attributes consistent with the spirit and scope of the present invention.

In FIG. 3, the social advertising product Salesforce Marketing Cloud 316 is ranked first with a product capability of 5.9 and a social sentiment value of 8.2 while LinkedIn is ranked 26th with a product capability value of 0.8 and social sentiment value of 4.9. As user 102 continues to answer questions displayed in question area 302, products continue to be ranked based on product capability and social sentiment.

The ranking order may change, and products not meeting the user's constraints may be eliminated. User 102 may also use “Add to Shortlist” button 318 to manually add desired products to the shortlist of products.

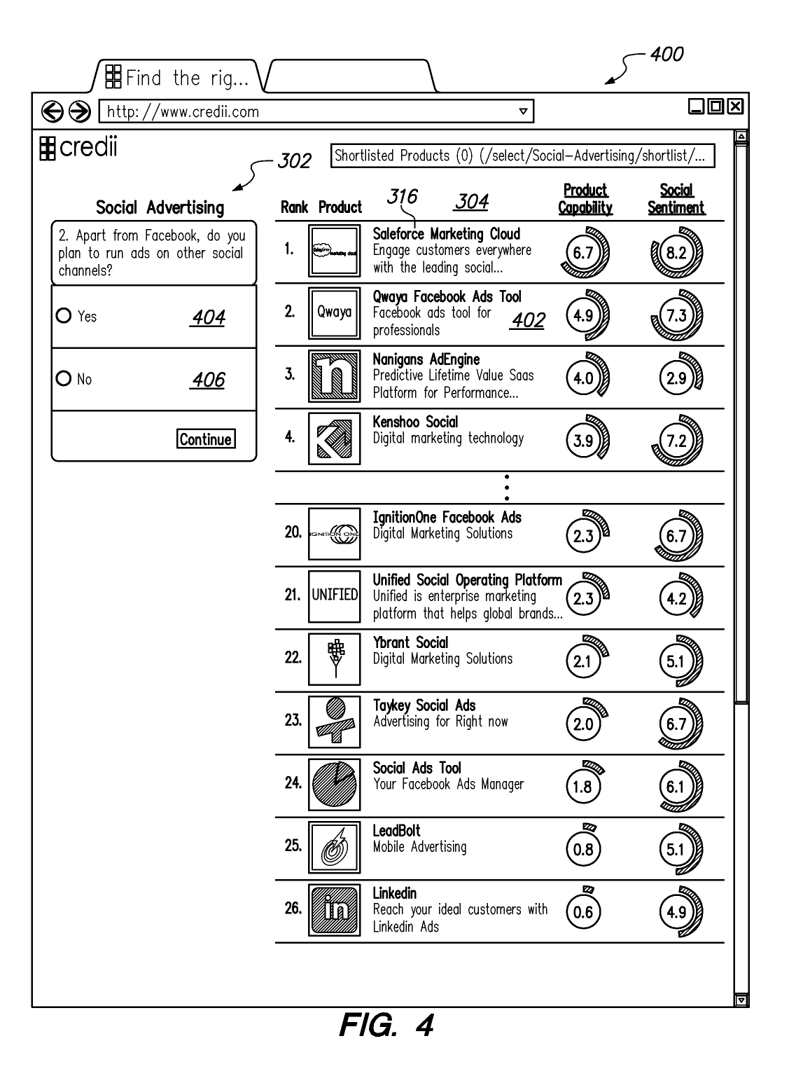

Here, user 102 has selected response 306, 308 and 310 in response to Question 1 “Why do you want to run a social ads campaign?” After response selection, user 102 can then select continue button 322, which then generates social advertising interface 400 of FIG. 4.

In FIG. 4, as can be seen within product and service listing area 304, Salesforce Marketing Cloud 316 still ranks first, although its product capability has further increased to 6.7 while its social sentiment rating remains at 8.2. Each iteration of questions may dynamically change product attribute values.

Social advertising product Qwaya Facebook Ads Tool 402, however, is now ranked second, replacing social advertising product Kenshoo Social, that was previously ranked second in FIG. 3. Thus, product rankings are dynamic and may vary based on responses and constraints entered by user 102.

Note also that the number of products displayed in the shortlist of FIG. 4 remains at 26 even when product rankings are varied. Note further that different responses by user 102 may reduce the number of displayed products. For example, if only response box 306 (FIG. 3) is selected, the number of displayed products may be reduced.

In FIG. 4, Question 2 in question area 302 is also generated along with the products shortlist in product and service listing area 304. Specifically, Question 2 asks: “Apart from Facebook, do you plan to run ads on other social channels?” User 102 may select either Yes 404 or No 406.

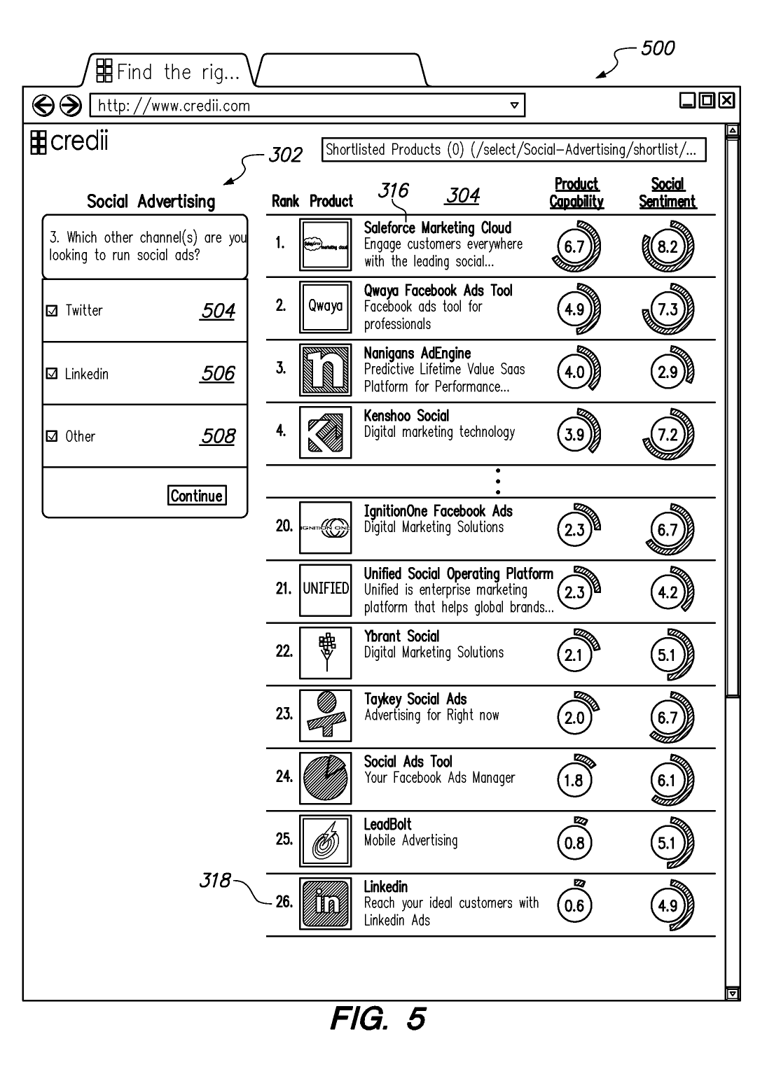

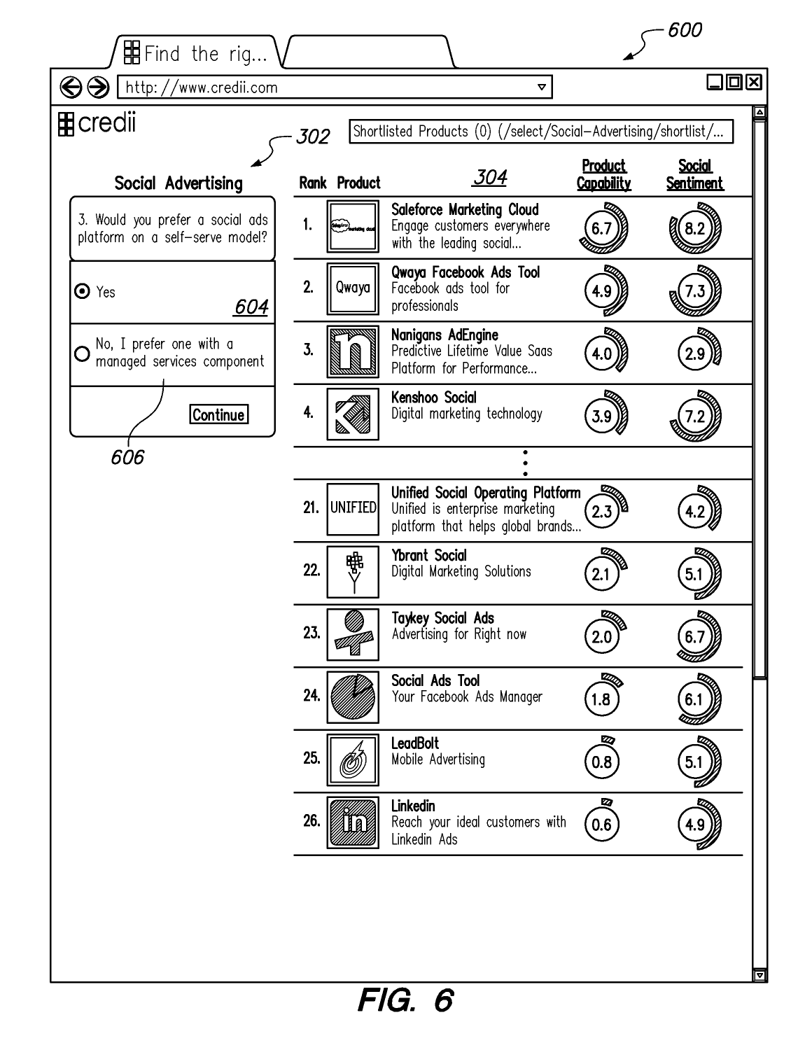

If No 406 is selected in FIG. 4, Question 3 is displayed in question area 302 as shown in FIG. 6. Here, Question 3 asks whether the user would prefer a social ads platform on a self-serve model. A user can respond by selecting Yes 604 or No 606. Note also that the shortlist in product and service listing area 304 of FIG. 6 remains the same as that of FIG. 5.

If Yes 404 is selected in FIG.4, social advertising interface 500 of FIG. 5 having a different Question 3 in question area 302 is generated. A corresponding shortlist of products, beginning with Salesforce Marketing Cloud 316 and ending with LinkedIn 318 is also displayed in product and service listing area 304 of FIG. 5. Here, Question 3 asks “On which other channels are you looking to run social ads?” Response options are Twitter 504, LinkedIn 506 and Other 508.

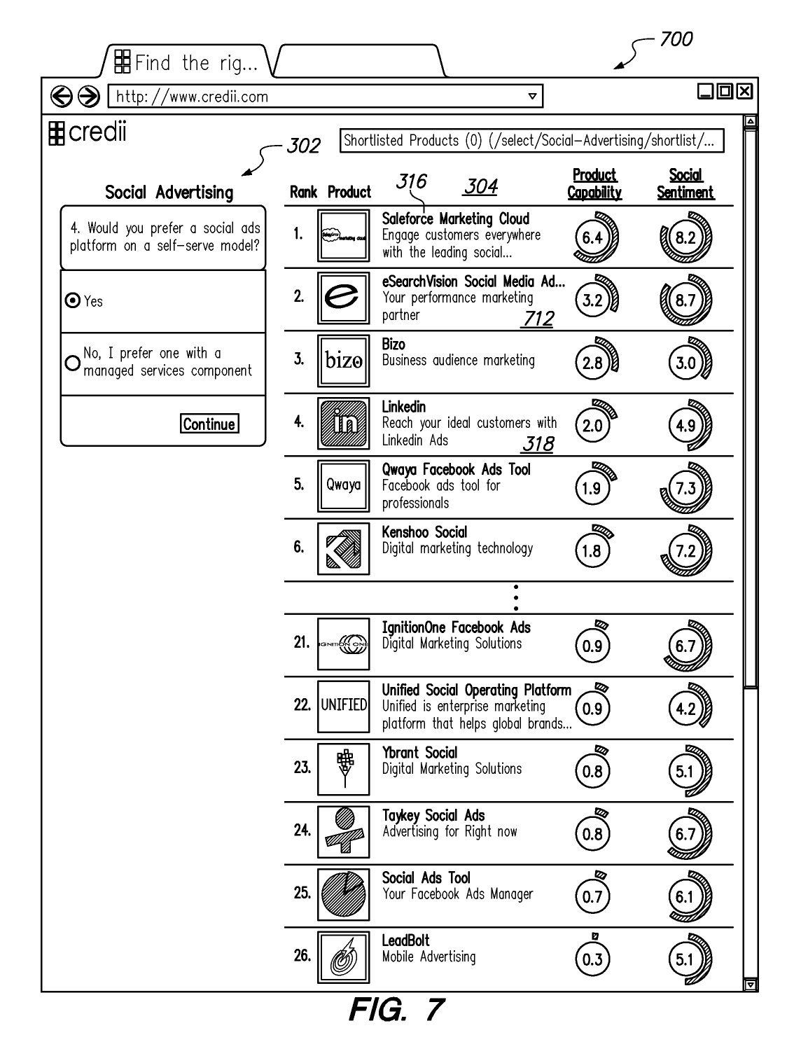

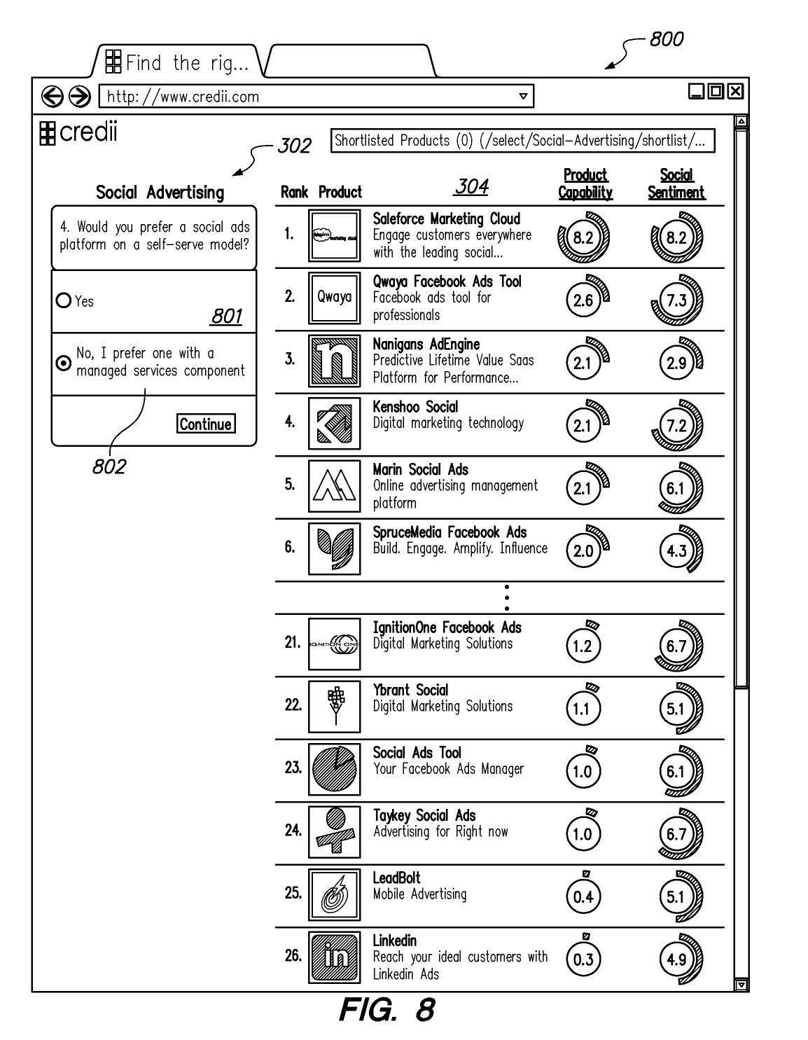

If all response options Twitter 504, LinkedIn 506 and Other 508 are selected, recommendation server system 104 generates social advertising interface 700 of FIG. 7. If a single response option i.e., Twitter 504 is selected, social advertising interface 800 of FIG. 8 is displayed.

Referring to FIG. 7, the question displayed in question area 302 is Question 4; a corresponding shortlist is displayed in product and service listing area 304 of FIG. 7. Here, it can be seen that Salesforce Marketing Cloud 316 continues to be ranked first, whereas eSearchVision Social Media Advertising 712 is now ranked second in comparison to the shortlists of FIGS. 5 and 6.

LinkedIn 318, which ranked last (26 of 26) in FIG. 5 is now ranked fourth with a product capability rating of 2.0 and a social sentiment rating of 4.9. This makes sense as user 102 has selected a constraint in FIG. 5 check box 506 that LinkedIn would be utilized to run social ads.

If a single response option, i.e. Twitter 504, is selected responsive to Question 3 of FIG. 5, social advertising interface 800 of FIG. 8 is displayed. Here, the shortlist of product and service listing area 304 has the same number of products as that of FIG. 7 although the ratings and rankings of said products have changed. Social advertising interface 800 also displays Question 4 “Would you prefer a social ads platform on a self-serve model?” to which user 102 may select Yes 801 or No 802.

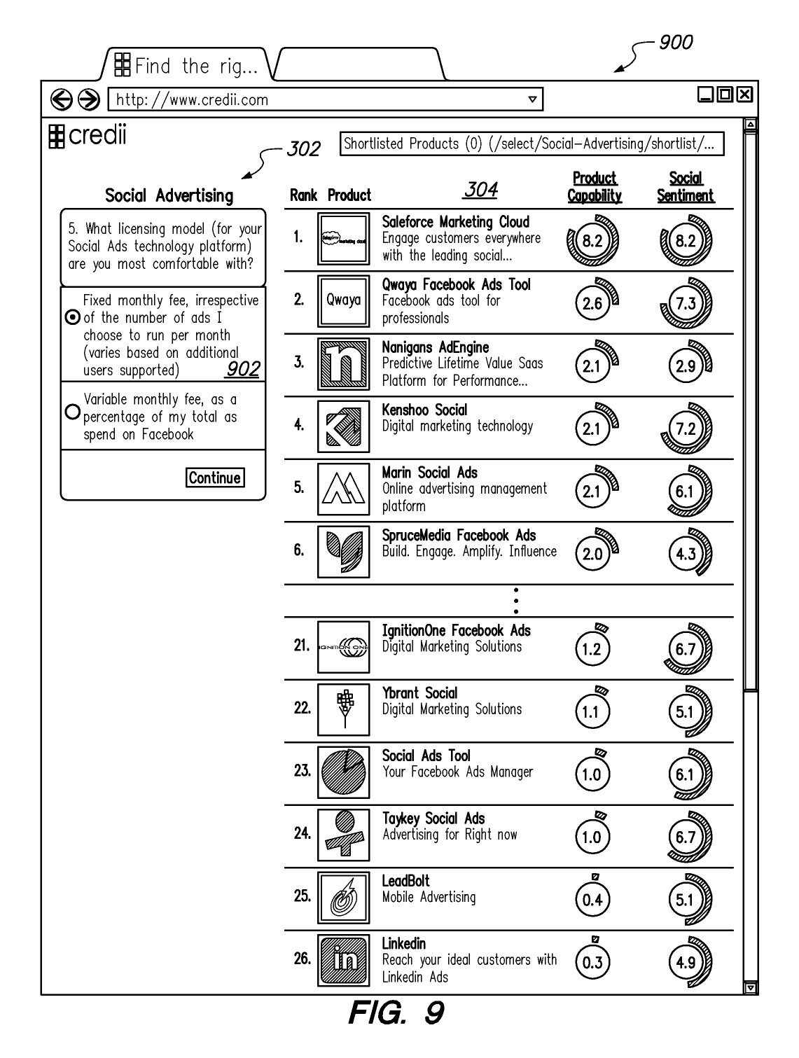

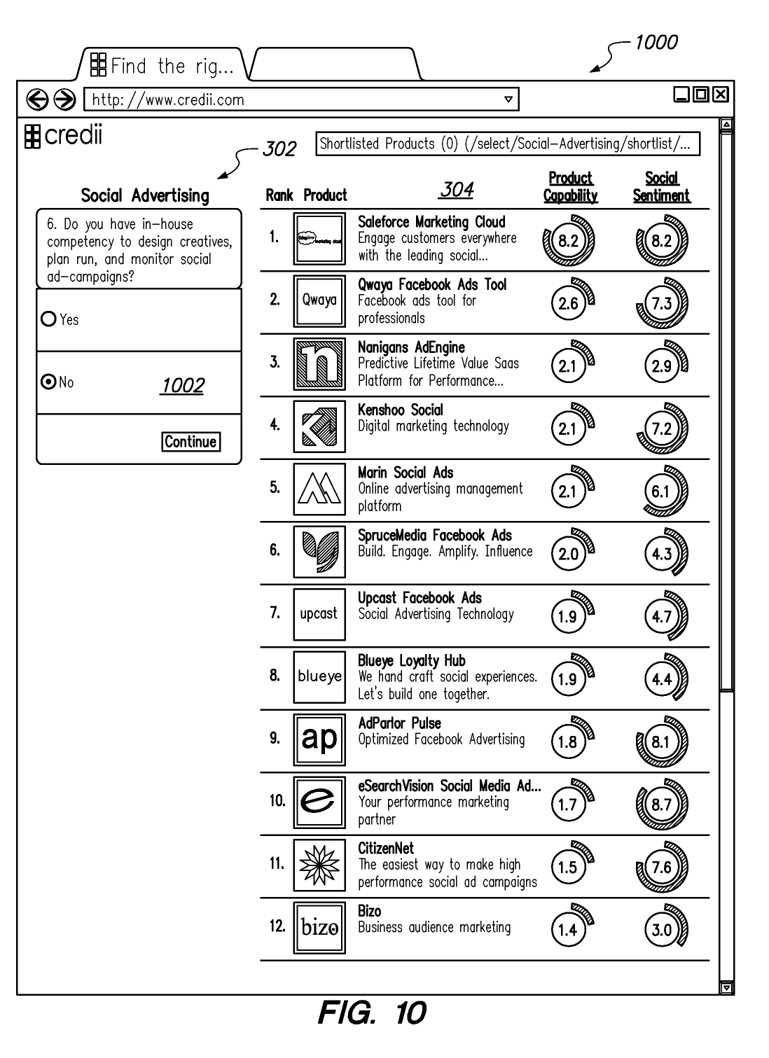

Selecting No 802 generates social advertising interface 900 of FIG. 9 that displays Question 5, “What licensing model (for your Social Ads technology platform) are you most comfortable with?” in question area 302 and a shortlist in product and service listing area 304 as shown. Selecting response 902 “Fixed monthly fee” in response to Question 5 generates Question 6 of social advertising interface 1000, “Do you have in-house competency to design creatives, plan, run, and monitor social ad campaigns?” as well as a shortlist in product and service listing area 304 of FIG. 10.

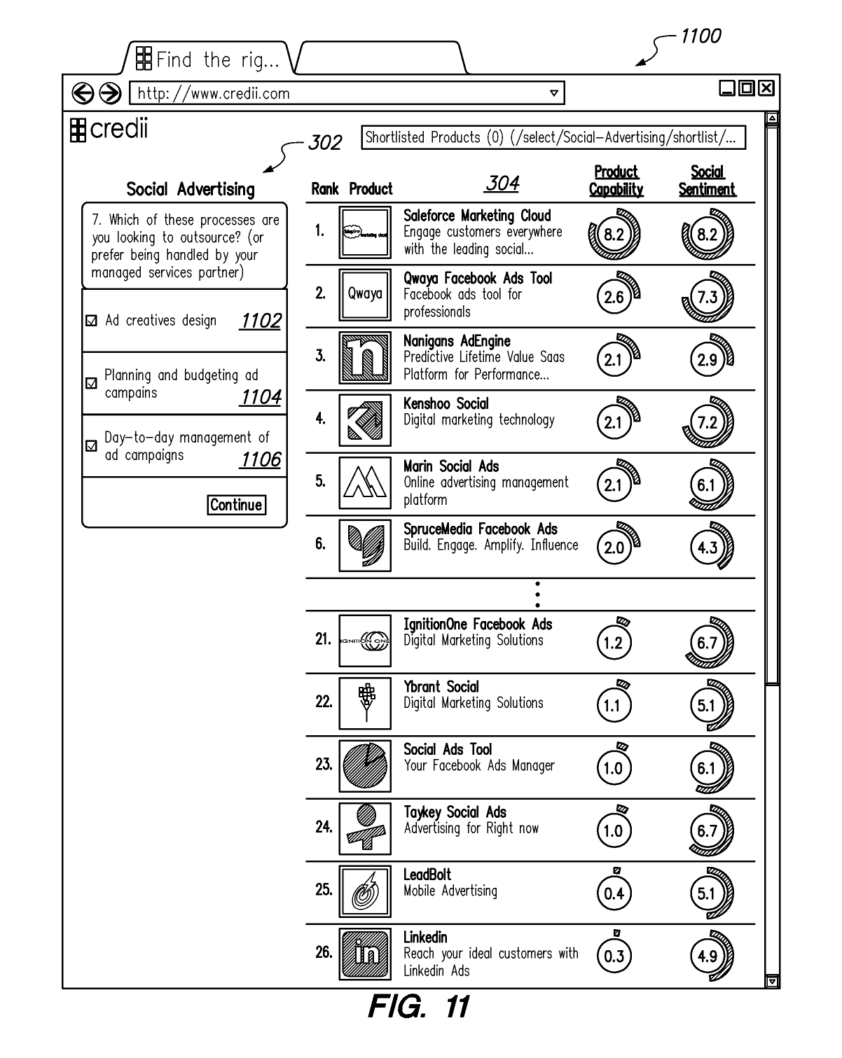

In FIG. 10, selecting response No 1002 responsive to Question 6, generates social advertising interface 1100 of FIG. 11.

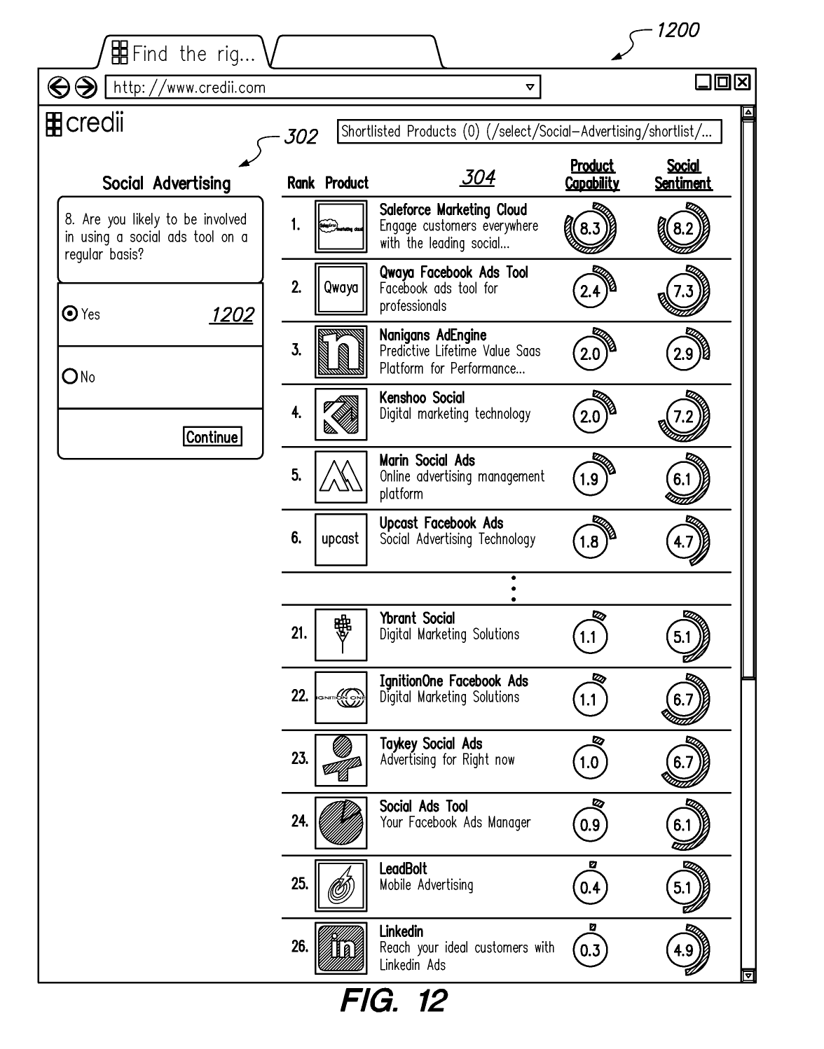

In FIG. 11, Question 7, “Which of these processes are you looking to outsource? (or prefer being handled by your managed services partner) is generated in question area 302, and a shortlist is generated in product and service listing area 304. Selecting responses 1102, 1104 and/or 1106 in response to Question 7 generates social advertising interface 1200 of FIG. 12.

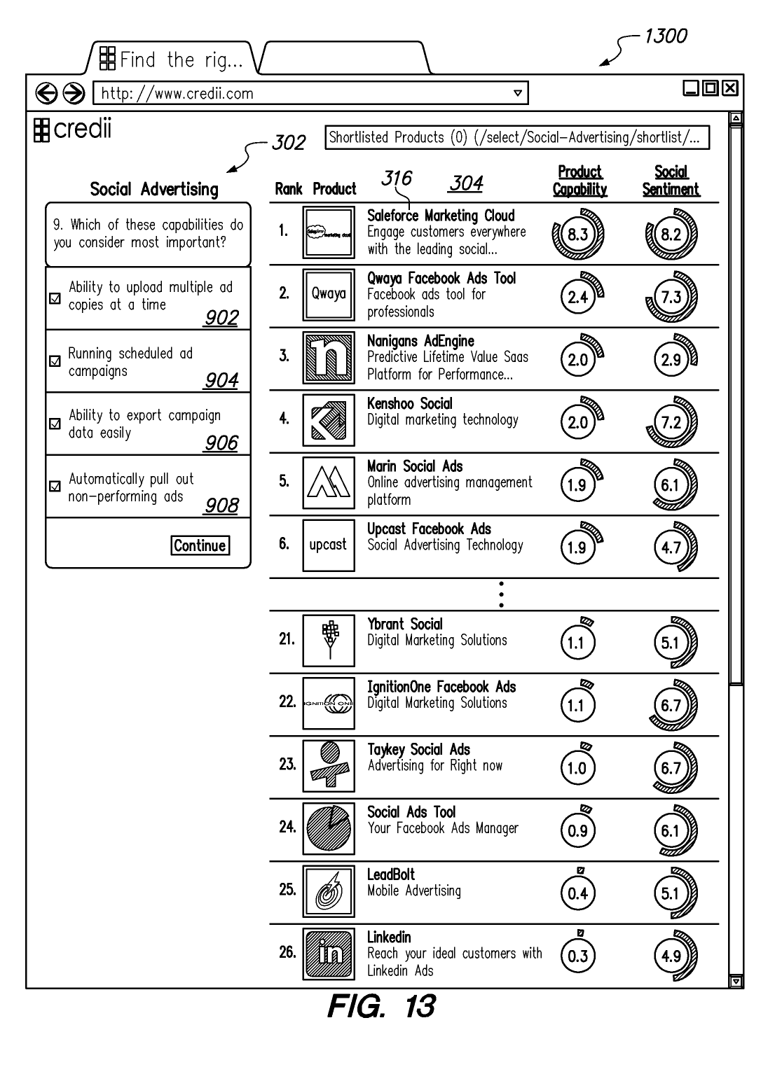

In FIG. 12, social advertising interface 1200 includes Question 8 generated in question area 302, “Are you likely to be involved in using a social ads tool on a regular basis?” and a shortlist in product and service listing area 304. Selecting Yes 1202 in response to Question 8 generates social advertising interface 1300 of FIG. 13.

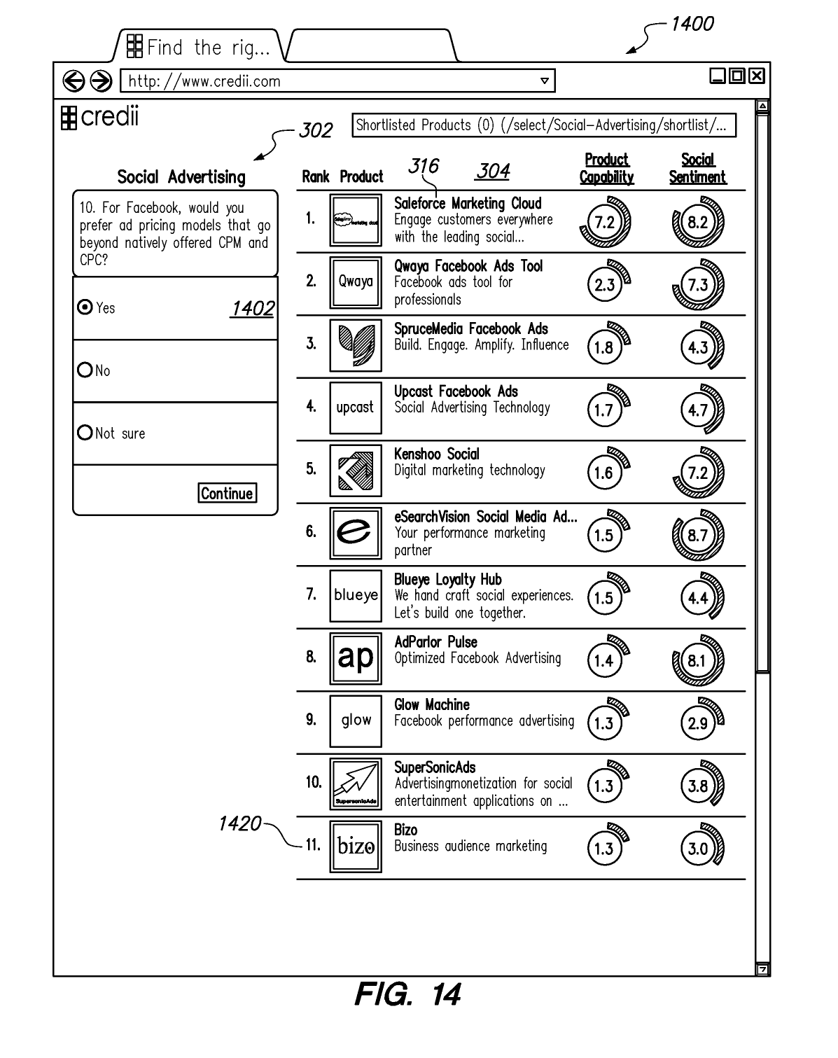

In FIG. 13, Question 9, “Which of these capabilities do you consider most important?” is generated in area 302 while a shortlist is generated in product and service listing area 304. Selecting responses 902, 904, 906 and 908 in response to Question 9 generates social advertising interface 1400 of FIG. 14.

In FIG. 14, note that the number of products on the shortlist is reduced from 26 products to only 11 products with Salesforce Marketing Cloud 316 ranked first and Bizo indicated as 1420 ranked 11^{th}.

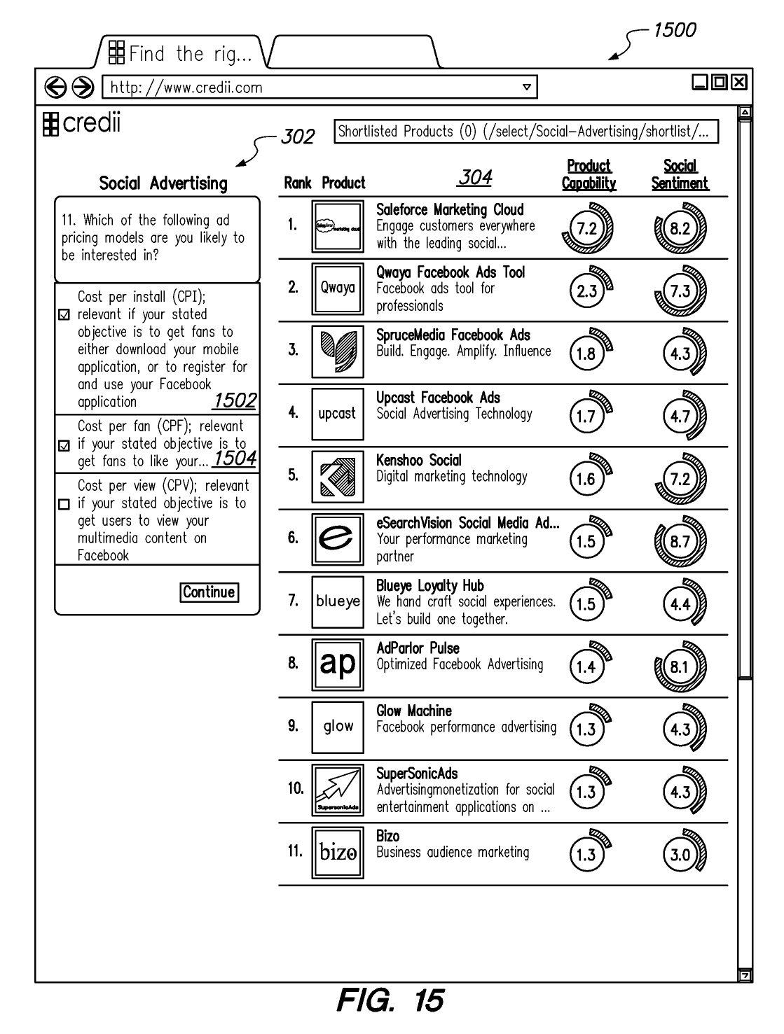

In FIG. 14, Question 10, “For Facebook, would you prefer ad pricing models that go beyond natively offered CPM and CPC?”, is generated in area 302 while a shortlist is generated in product and service listing area 304. Selecting response 1402 Yes in response to Question 10 generates social advertising interface 1500 of FIG. 15.

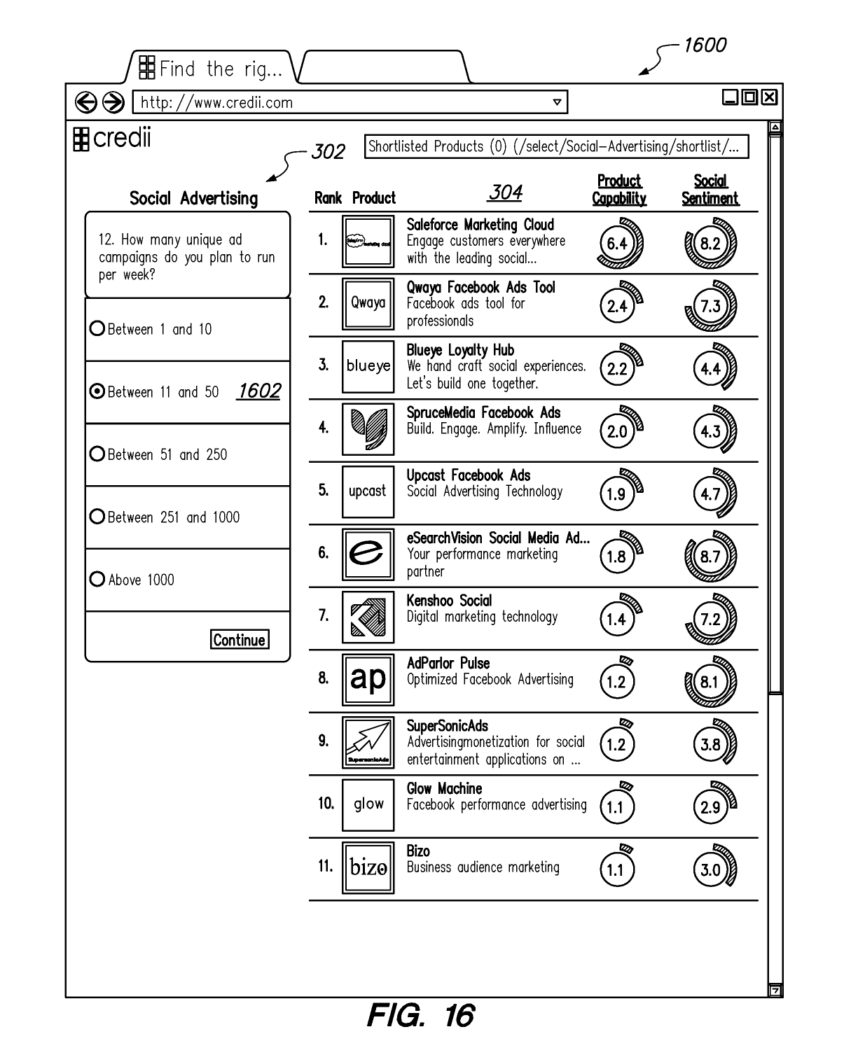

In FIG. 15, social advertising interface 1500 includes Question 11, “Which of the following ad pricing models are you likely to be interested in?” in response area 302 as well as a shortlist in product and service listing area 304. This shortlist remains at 11 products. Selecting responses 1502 and/or 1504 in response to Question 11 displays social advertising interface 1600 of FIG. 16.

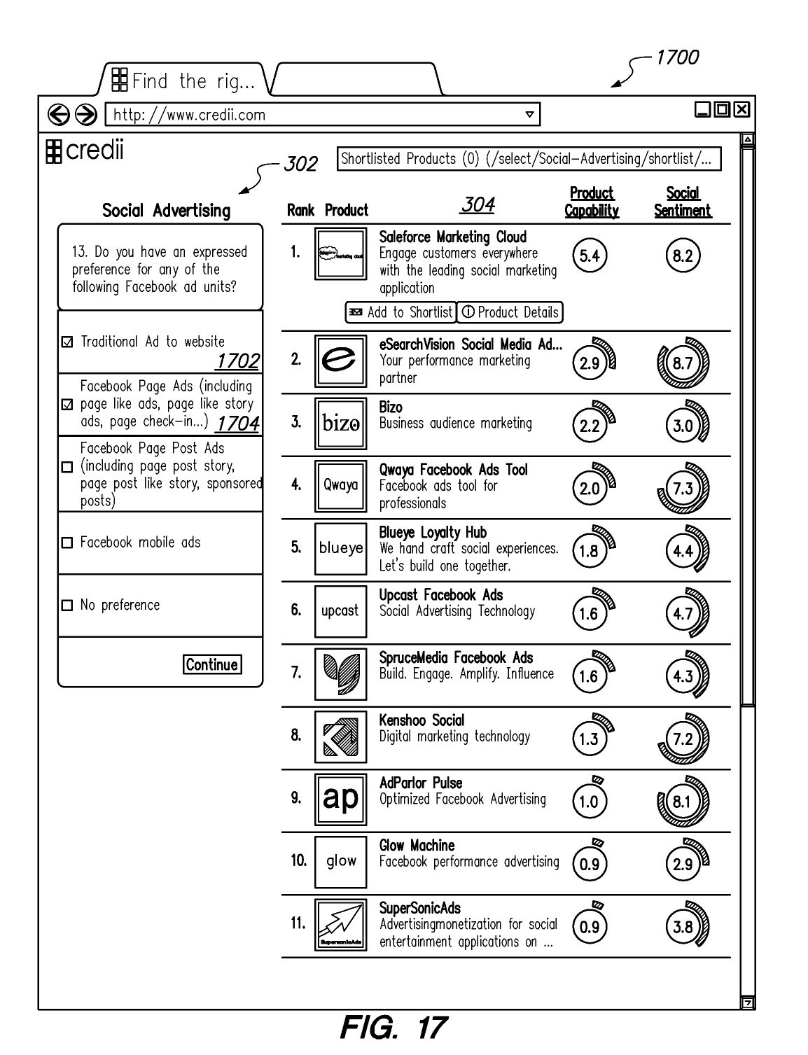

In FIG. 16, social advertising interface 1600 includes Question 12, “How many unique ad campaigns do you plan to run per week?” is generated in area 302, and a shortlist is generated in area 304. Selecting response 1602 “between 11 and 50” in response to Question 12 displays social advertising interface 1700 of FIG. 17.

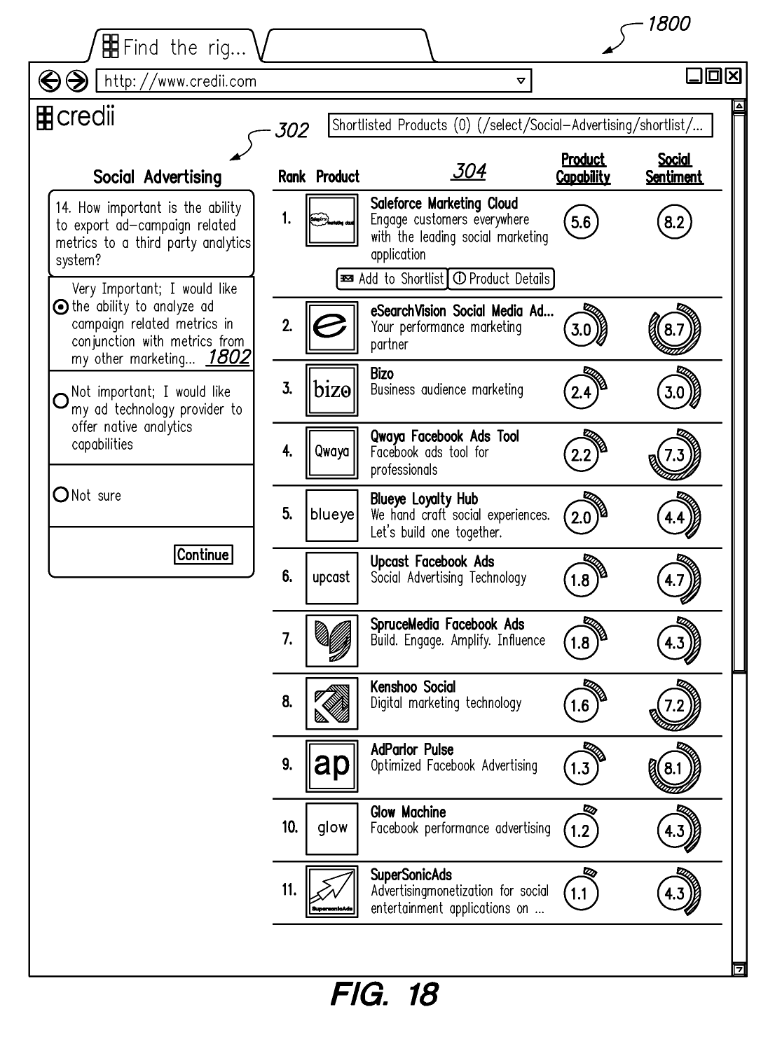

In FIG. 17, Question 13, “Do you have an expressed preference for any of the following Facebook ad units?” is generated in area 302 and a shortlist is generated in area 304 as shown. Selecting responses 1702 and/or 1704 responsive to question 13 of FIG. 17 generates social advertising interface 1800 of FIG. 18, said interface having Question 14, “How important is the ability to export ad-campaign related metrics to a third party analytics system?” in area 302 and a shortlist in area 304.

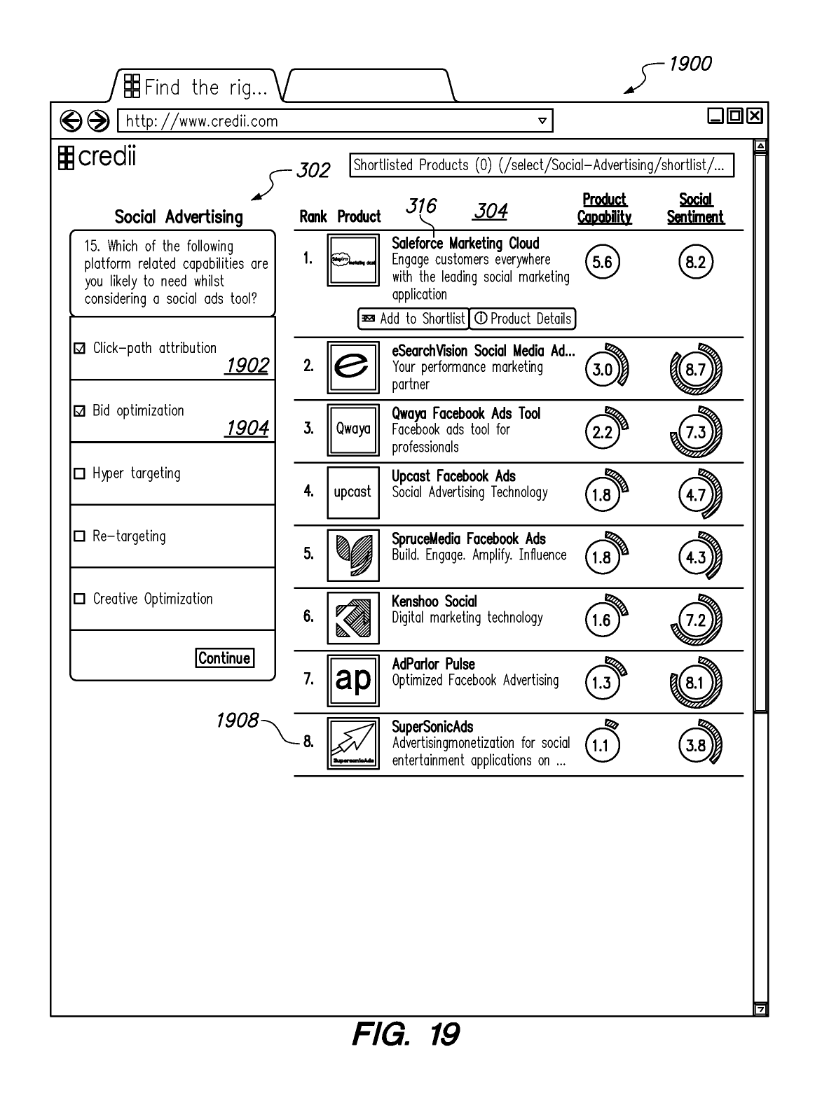

Selecting response 1802 “very important” responsive to Question 14 generates social advertising interface 1900 of FIG. 19 having Question 15, “Which of the following platform related capabilities are you likely to need whilst considering a social ads tool?” in area 302 and a shortlist in area 304. Note here that the shortlist has only 8 products with Salesforce Marketing Cloud 316 ranked first and SuperSonicAds 1908 ranked 8^{th}.

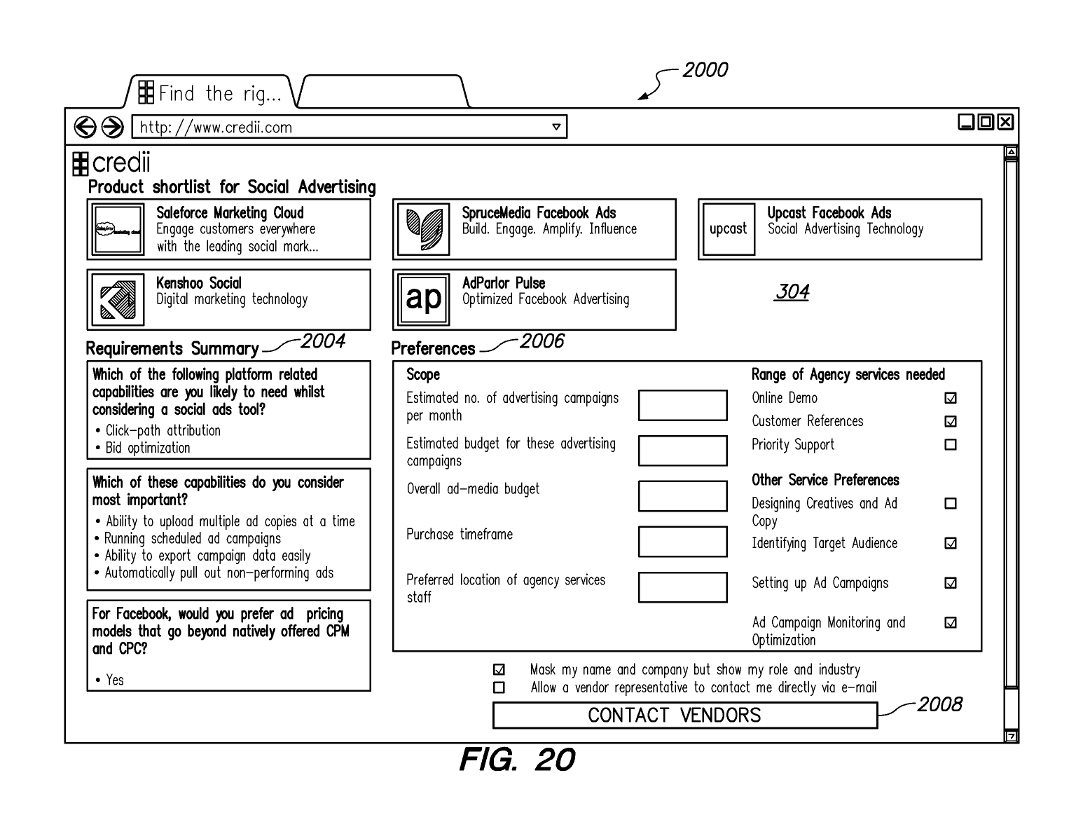

Selecting 1902 and/or 1904 responsive to Question 15 of FIG. 19 generates social advertising interface 2000 of FIG. 20. Here, social advertising interface 2000 displays the final shortlist with only five products displayed within product and service listing area 304.

A constraint summary 2004 showing all of user 102's constraints and user 102's preferences are also shown. Another advantage of the present invention is that upon user 102 selecting the “contact vendors” button 2008, recommendation server system 104 can also contact vendors on behalf of user 102 for products appearing on the final shortlist.

In one embodiment, the system and method of the present invention enables decision makers in businesses to crystallize their business use-case, research various products available in the market, build a shortlist that reflects their particular circumstances and send out RFPs (Request for Proposals) to a select group of vendors.

Example of a business use case or need or a type of product or service that the business is seeking is “To monitor mentions of my brand on social media.” In this exemplary embodiment, the system and method of the present invention helps the business user in zeroing in on the right product or service for listening to online chatter about his brand across various channels.

In one embodiment, the recommendation system and method keeps asking the right questions based on user responses until a very small subsection of the products or service is still remaining in the reckoning. Thus, an advantage of the present invention is that the system and method of the present invention provides a platform to simulate a dialog with an expert blending guidance, product research and social signal into an intuitive experience.

FIG. 20A illustrates guided and interactive method 2050 according to an exemplary embodiment of the present invention.

Specifically, in FIG. 20A, enterprise user 110 of FIG. 1 may utilize method 2050 to select from a multiplicity of available products and services. Enterprise user 110 might wish to receive recommendations for products, services, solutions, frameworks, approaches or other such information or items consistent with the principle and scope of the present invention.

At block 2052, method 2050 involves storing by enterprise user 110 and receiving by recommendation server system 104 a user profile for the user. The profile may include simple demographic information such as the user's role in an organization, the user's location, etc. The profile may also include information derived by an analytical model based on information stored in the profile.

The profile may also be based on previous interactions with the recommendation server system. Multiple interactions from individuals are also stored in the individual's profile. Multiple interactions from individuals from the same company can be stored to form a company profile as well.

At block 2054 of method 2050, enterprise user 110 might select a type of product or service for which a recommendation is sought. Selection might be from a products and services list from which a particular selection might be made (via a drop-down menu, etc.). As an example, as shown in FIG. 2, enterprise user 110 may be searching for and may select software “For video conferencing.”

As another example, enterprise user 110 may be seeking software “To monitor mentions of my brand on social media.” Further yet, enterprise user 110 may be seeking software to “To run ad campaigns on social media.” In an alternate embodiment, selectable options are not presented to users. Rather, a user may enter in a form field the type of product or service that the user is seeking

At block 2056, an initial ranking for the products or services is generated by the system. Here, extensive and in-depth profiles of many relevant products and services have been stored in database 108.

System engineers and analysts manually research and determine product features and attributes for storage on database 108. Thus, an advantage of the present invention is that extensive and relevant product profiles to which many users would otherwise have no access but for the present invention are available for ranking using the present invention.

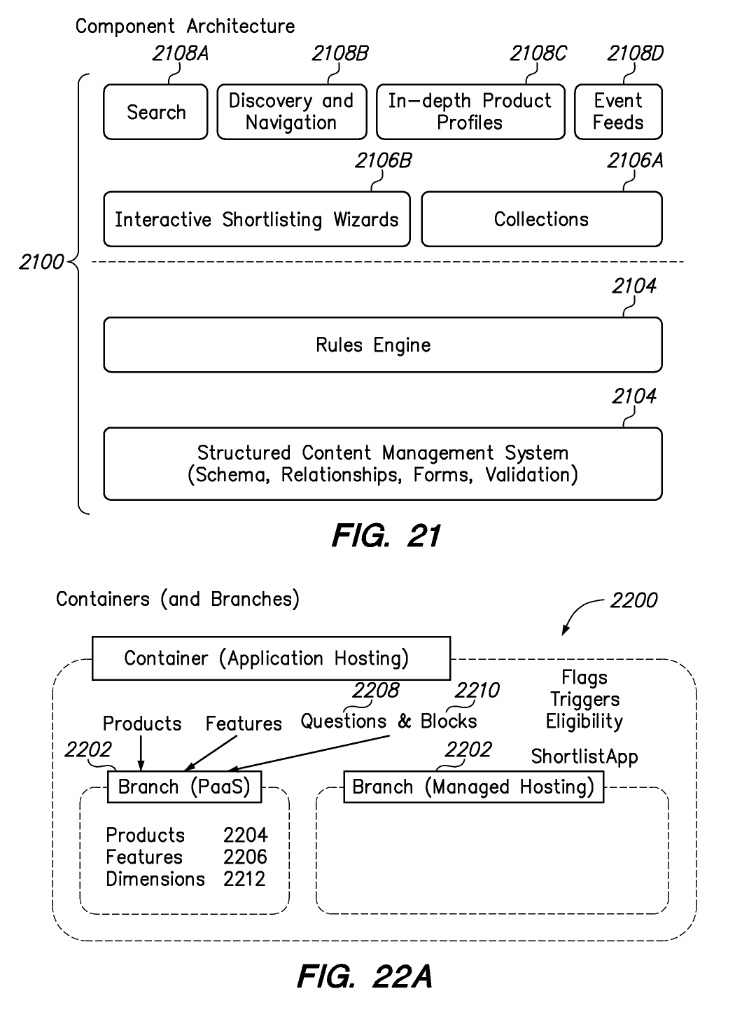

As an example, as shown in FIG. 22B, examples of product profiles (for social media campaigns) that are stored include Webfluenz™, Salesengine™, Salesforce Pardot Ultimate™, Adobe Campaign™, and Marqui™. Not many users would have the inclination, skill, technical ability, etc. to research a single product and its features much less many products available for ranking in one embodiment of the present invention.

The initial ranking is partly dependent upon on a vector having at least two dimensions. One dimension may be product capability. As implied by its name, a product capability rates the product function and to what extent such functions are suitable for a user. Another dimension might be social sentiment, which is a measure of how well a product is perceived by its users and customers. As a further example, a product may be ranked based on both product capability as well as social sentiment. Although not shown, products or services may be based on additional dimensions or attributes consistent with the spirit and scope of the present invention.

The initial ranking is also partly dependent upon the user profile as well as the product and service profiles. For example, two different user profiles with different industry roles may see the same products ranked differently.

Further, scores for the initial (and subsequent) ranking may be based on calculation of an absolute score for each product as discussed below with reference to the Absolute Score for a Product section and the Feature Hierarchy, Leaf Features and Product Feature Grid section.

At block 2058, method 2050 involves generating a real time queue that can receive one or more blocks. The queue is a linear data structure for which all insertions are made at one end and all deletions are made at the other. Thus, each block is inserted into the rear of the queue and removed when it reaches the front.

Each block within the queue aggregates a plurality of related questions, which may be presented to and asked of enterprise user 110. This is another advantage of the present invention. Blocks with aggregated questions avoid the need to ask users multiple and irrelevant questions creating efficiencies that are unavailable with any conventional system. The setting of too many question eligibility flags can also avoided.

At block 2060, an initial block to be generated and moved into the real time queue is determined. In one embodiment, the initial block is a default block that is mapped to the need specified by enterprise user 110.

In another embodiment, determination is based in part, on at least the user profile, where a different initial block is moved into the queue dependent upon data inherited from the user profile. In a further embodiment, the initial block may be based on a flag condition for moving the initial block into the queue.

At decision block 2062, method 2050 involves traversing the initial block (now in the queue) to determine whether all of the questions including a first question and additional questions, if any, within the initial block will be displayed. All questions are not necessarily displayed simply because they are in the initial block.

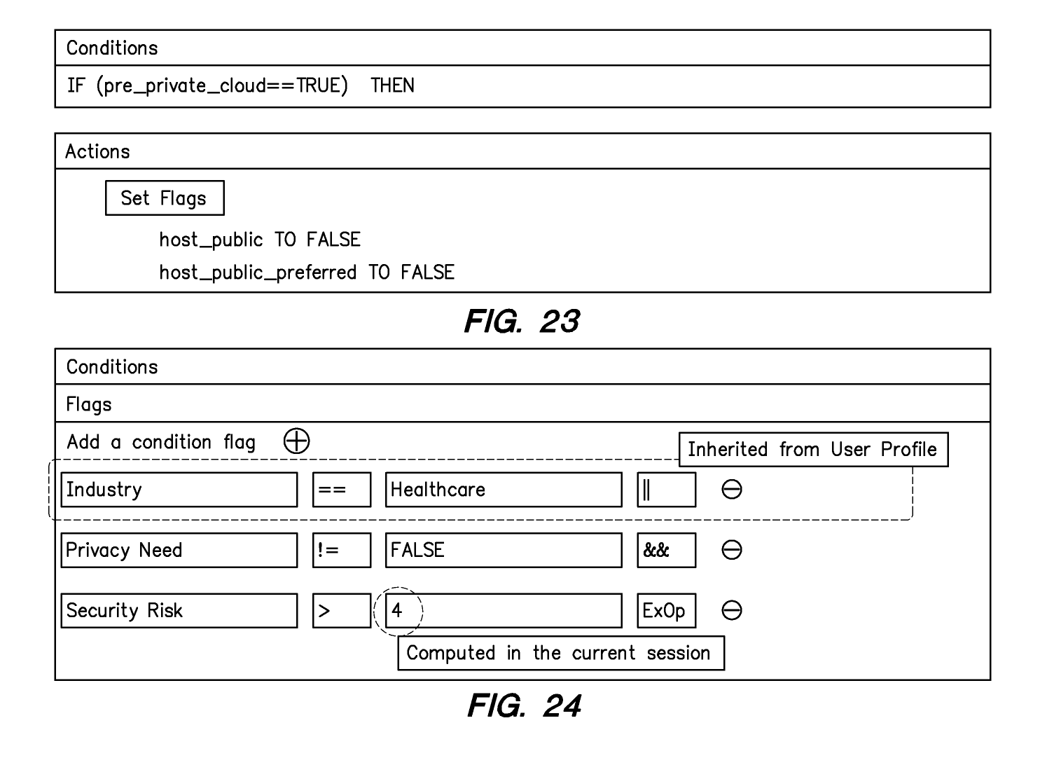

Whether a question is displayed is dependent upon on enterprise user 110's profile and whether the question eligibility condition is met based on a flag variable that sets the condition for displaying that question to enterprise user 110. A flag is a variable in the system, which can be used in a variety of scenarios as a key element of a conditional statement when operating on a trigger condition. Flags are further discussed with reference to FIGS. 24 through 26. If all conditional expressions of an Eligibility pass, the question is displayed, otherwise the next question in the same block is evaluated. Thus, if the question is eligible for display, flow proceeds to block 2068, where the question is displayed to enterprise user 110 for viewing and for selection of possible response options.

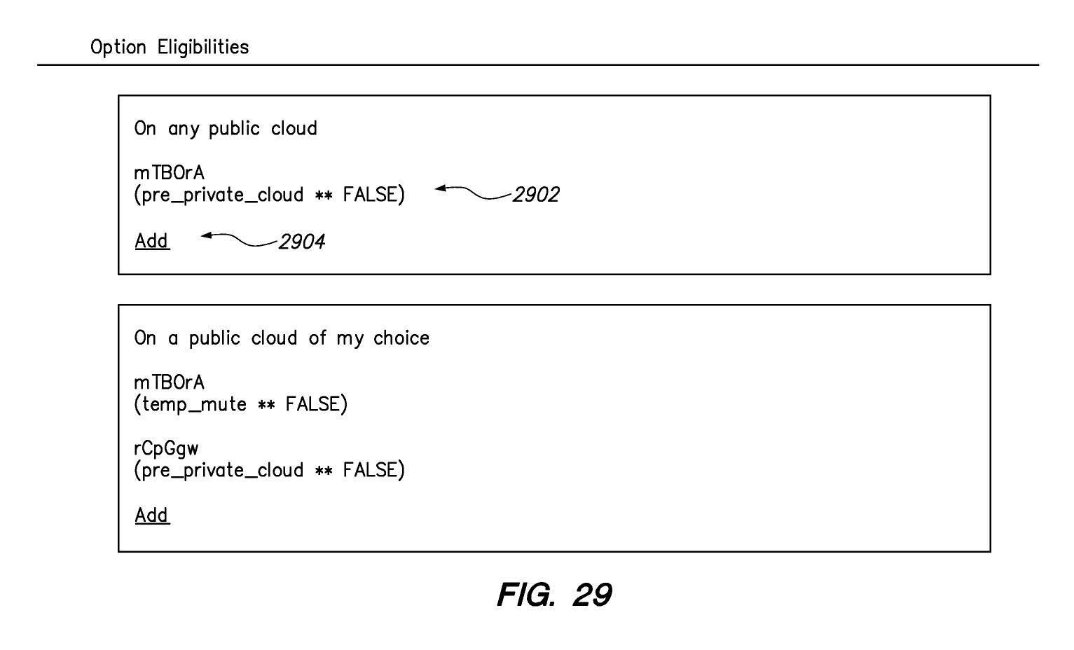

At block 2070, for the displayed question, method 2050 determines a plurality of response options that are to be displayed for selection by the user responsive to that question. In one embodiment, the response options may be mapped to the question. In another embodiment, the response options may be dependent on mapping the response options to the question and on the flag variable being set to an eligibility condition. Further yet, the response options might be dependent on the flag variable being set to an eligibility condition. If a response option is not eligible, that option is skipped and the next response option is evaluated. This process is continued until all response options are processed. Eligibility conditions are further discussed with reference to FIG. 29 below and the Eligibilities section, below.

At block 2072, the eligible response options are displayed. See, for example, FIG. 3, 306, 308 and 310, 312.

At block 2074, enterprise user 110 selects one (or more) of the response options and the selected option is stored by the system. See, for example, FIG. 3, 306, 308, 310. Specifically, enterprise user 110 can select one or more of response 306 “Gain more fans and followers on my social pages,” response 308 “Get more users to register for and use my Facebook application,” response 310 “Drive sign-ups on my website,” or response 312 “Drive mobile app installs.” Note that the user may select only one option if desired.

At block 2076, method 2050 involves then involves recomputation of the rankings based on the response options selected by enterprise user 110. This is another novel advantage of the present invention. To capability to re-compute rankings for hundreds of products and services, in real time, quickly over and over again by considering and reconsidering the user's selected response options is a novel advantage of the present invention not herein before seen in conventional systems and methods.

Specifically, the method involves providing for display, a recomputed ranking for the products or services where the previous lower rankings of products and services may be amplified (additional factor set by user) or increased or ranking of products and services previously ranked higher may be lowered. The recomputed ranking can be dependent upon selected response options and on the vector with two dimensions.

At decision block 2078, if an additional question exists in the initial block, flow returns to decision block 2062 and that additional question is then processed as previously discussed. Otherwise, if there is no additional question, flow proceeds to decision block 2080.

At decision block 2080, the method proceeds to the next block of questions, if any. Specifically, it is determined whether an additional block exists in the real time queue. If yes, flow proceeds again to decision block 2062 to process the first question in the additional block as previously discussed. If there are no additional blocks, flow proceeds to end block 2090, where guided and interactive method 2050 is terminated. Here, a shortlist of products may then be created and displayed to the user.

Referring now to decision block 2062, if the first question is not eligible for display, flow proceeds to block 2064.

At block 2064, the first question is skipped and not displayed because the condition for displaying that first question is not met. Flow then returns to decision block 2078 to process additional questions if any, as previously described.

### Component Architecture

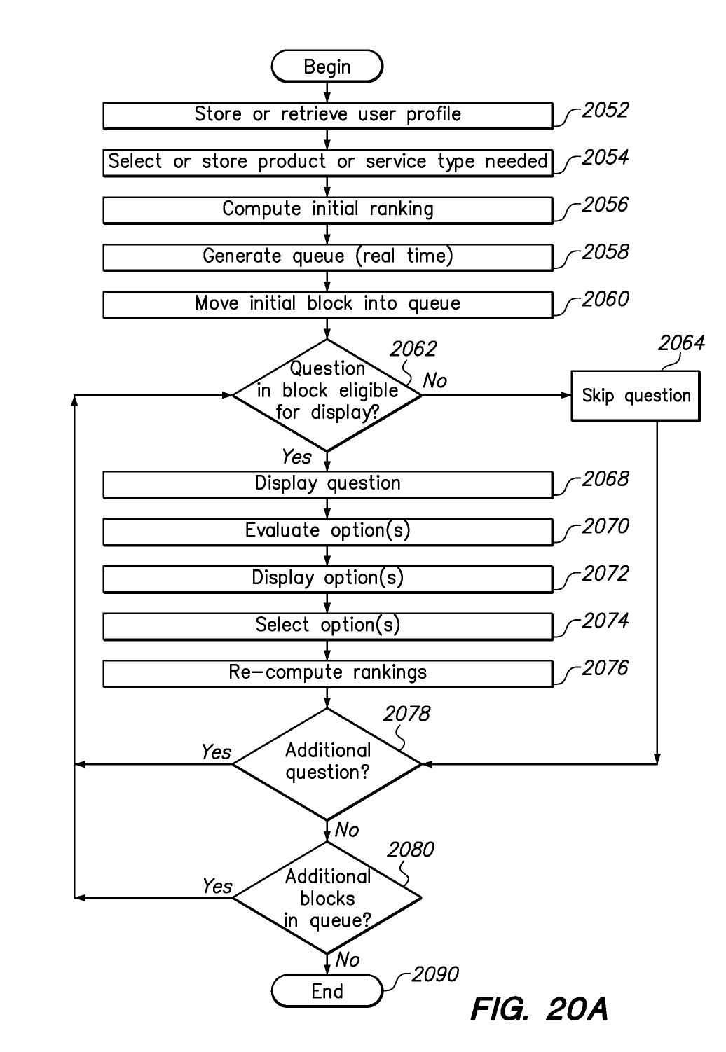

In one embodiment, the present recommendation system and method can be roughly divided into a mesh of four groups of interoperating functional modules 2100 as shown in FIG. 21. Functional modules 2100 include Structured Content Management System (CMS) 2102, rules engine 2104, collections 2106A, interactive shortlisting wizards 2106B , search 2108A , discovery and navigation 2108B, in-depth product profiles 2108C and event feeds 2108D.

### The Structured Content Management System

As shown in FIG. 21, CMS 2102 enables analysts to store and publish granular research data including product specific information, feature hierarchy and the logic that makes up the Rules Engine 2104.

Container Architecture

FIG. 22A shows a container 2200 according to an exemplary embodiment of the present invention. In one implementation, a container is an entity that is the highest level of abstraction with respect to data and logic. The containerization is not arbitrary but is based on loosely defined software categories.

Branches 2202 of FIG. 22A and various other components are further discussed below. Examples of containers are: Social Media, Customer Relationship Management;, Project Management, Productivity, Hosting, Collaboration. Other container types within the spirit and scope of the present invention are possible.

Here, the social media container 2250 of FIG. 22B abstracts all data for software that is catering to the business aspect of social media. As used herein and as shown in FIG. 22A, a branch is as an entry point to a Container. A branch can include all the key entities from a container along with its products, features and dimensions.

The branch abstraction helps in the reuse of existing research and makes creating new use cases quite quick. For example, say we have a Hosting Container, and a Branch PaaS (Platform as a Service). Using quite a lot of the same products, features and dimensions, we can quickly come up with another branch named mBaaS (mobile Back-end-as-Service). The following definitions are for a single embodiment and are provided not as limiting definitions but to exemplify and clarify the present invention.

Product: A product 2204 is an offering from a software vendor. While Microsoft is a “Company” entity in the present ecosystem, Azure is a “Product.” The same holds true with “Amazon” and “EC2.” Dropbox and Dropbox for Business are two independent products too. A product has a host of features to qualify it to be a certain Container. A product cannot belong to more than one Container. Feature: A Feature 2206 is a qualified capability that a product or a solution possesses. For instance, the feature defines whether or not and to which degree a particular product offers the ability to view reports.

A Question 2208 is a question that is asked of a user. It can be either single-choice or multiple-choice. An Option (not shown) is an available response to a question. A Block 2210 is a sequence of questions which can be logically grouped together. Dimension: a vector having at least the following dimensions may be used for ranking computations: 1. Product Capability and 2. Social Sentiment. Other vector dimensions within the spirit and scope of the present invention can be utilized. For example, Pricing, Usability, User Sentiment etc., on which we can rank and sort products.

A Flag is a variable in the system, which can be used in a variety of scenarios as a key element of a conditional statement when operating on a trigger condition. An eligibility entity may be QuestionEligibility or OptionEligibility, which encapsulates a condition. If the condition passes, the corresponding question or option is displayed (not skipped). A ShortlistApp is an extraction of a branch into a user facing non-admin entity. This is what our end users see and interact with.

### The Rules Engine for Question Parsing

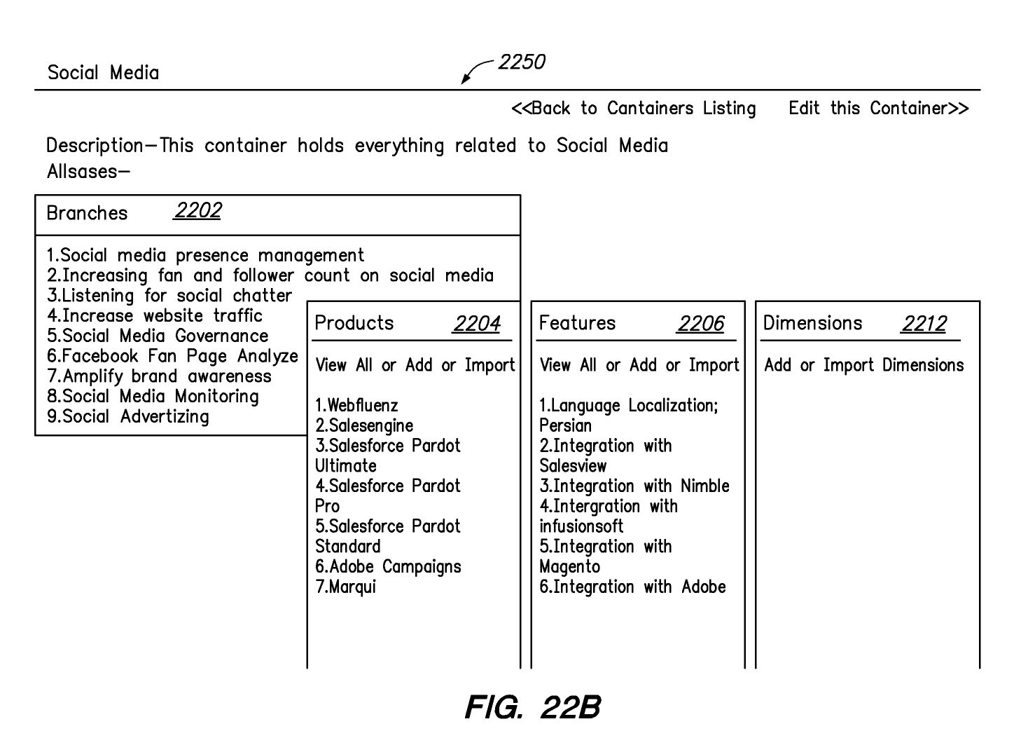

The primary components of the Rules Engine are Flags, Triggers and Eligibility. Other components may also be utilized. Key secondary components that are used for parsing and scoring include Flag Cache, Secondary Cache, Trigger Parser, Queue Processor and Scorer. Flags, as mentioned previously, are variables, and Triggers can be thought of as intitiators, which can set off a chain of actions including changing flag values. An example of a trigger is shown in FIG. 23. In one embodiment, there are five types of triggers, which are differentiated based on the “event” that is firing off these triggers. They are:

ContainerEntryTrigger—first entry in a Container;

ContainerExitTrigger—when a Container is exited—end of flow;

BranchEntryTrigger—first entry of a Branch;

BlockEntryTrigger—first entry of a Block;

BlockExitTrigger—when a block is exited;

QuestionExitTrigger—when a question has been responded to.

Alternatively, it can be said that these triggers are “fired” when the ShortlistApp moves from one state to another as further described below. A Trigger has a set of conditions; all of these make up an aggregated expression which when evaluated fires up the corresponding actions. The flags that make up the aggregated expression of a trigger are an amalgamation of variables which can be either standalone or can be inherited from other entities (say, user profile or company graph).

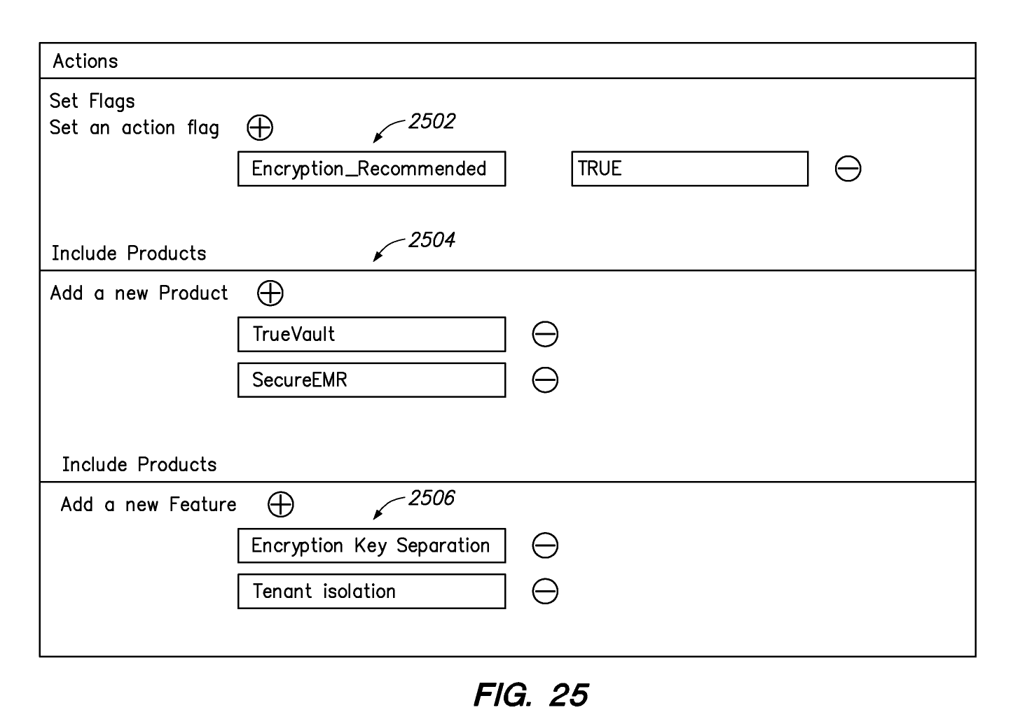

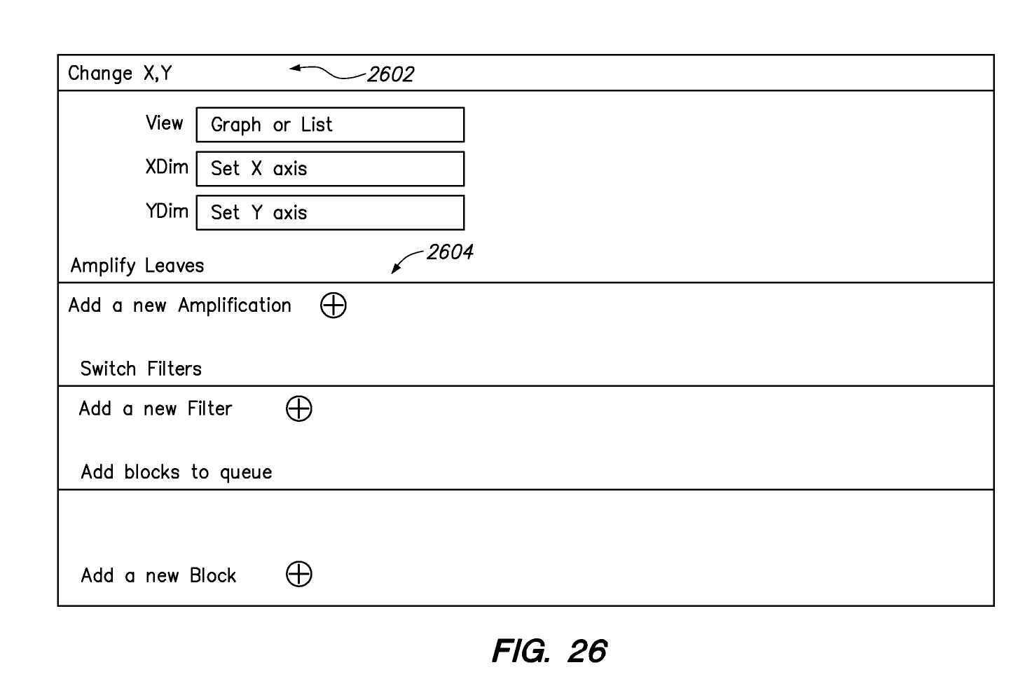

As shown in FIG. 24, several actions can be triggered upon the successful evaluation of a Trigger. These can be setting existing or new flag values, e.g., 2502 of FIG. 25; and if a flag is not present in the flag cache, it is instantiated and added to the flag cache; including new Products to the result set of products, e.g., 2504 of FIG. 25; including new Features, e.g., 2506 of FIG. 25, to the already existing set of features; changing the X and Y dimension (e.g., Product Capability and Social Sentiment), e.g., 2602 of FIG. 26; changing the view (Graph or List); amplifying the value of some features that make up the product capability or any other dimensions, e.g., 2604 of FIG. 26; setting filters on or off to eliminate products; and add additional blocks of questions to the Block Queue.

Question Parsing Architecture

The ShortlistApp is the user-facing entity that abstracts the logic and data of the branch, which is manually seeded. Whenever a URL like https://Credii.com/select/Platform-as-a-Service/ is accessed, a ShortlistApp with the name ‘Platform as a Service’ is invoked.

The ShortlistApp inherits all the data and logic from the corresponding branch (with the same name) and then builds a flag cache, a secondary cache and a block queue. The resulting processing of a combination of data manipulation methods by the modules (QueueProcessor and TriggerParser) on all the above-mentioned entities results in the first App State for the user.

The QueueProcessor forms a queue of blocked questions—the superset—that can be asked to the user in a sequential manner based on the user responses. It does this by systematically invoking the module TriggerParser that assimilates all the triggers that need to be fired, checking their conditions for eligibility and processing the actions of these triggers.

To arrive at the first question that will be shown to the user, the TriggerParser first processes the ContainerEntry triggers that are associated with the ShortlistApp being accessed (via the branch). It then goes on to process the BranchEntryTriggers that may be present for the branch.

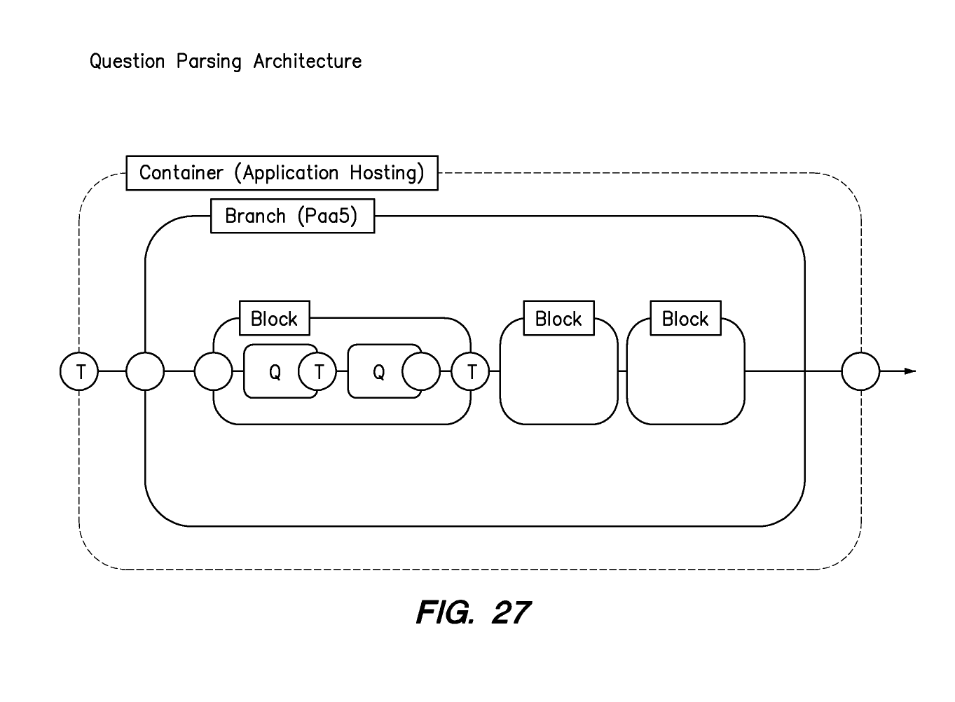

In one embodiment, the first block of the Container is then auto-placed in the queue and its BlockEntryTriggers are processed. In an alternate embodiment, an appropriate block is determined as the first block to be placed in the queue. Questions belonging to this block are then sequentially processed with the question that is first to have its eligibility condition satisfied being displayed to the user. An exemplary question parsing architecture is shown in FIG. 27, where triggers T and questions Q are shown.

AppState—The State Machine

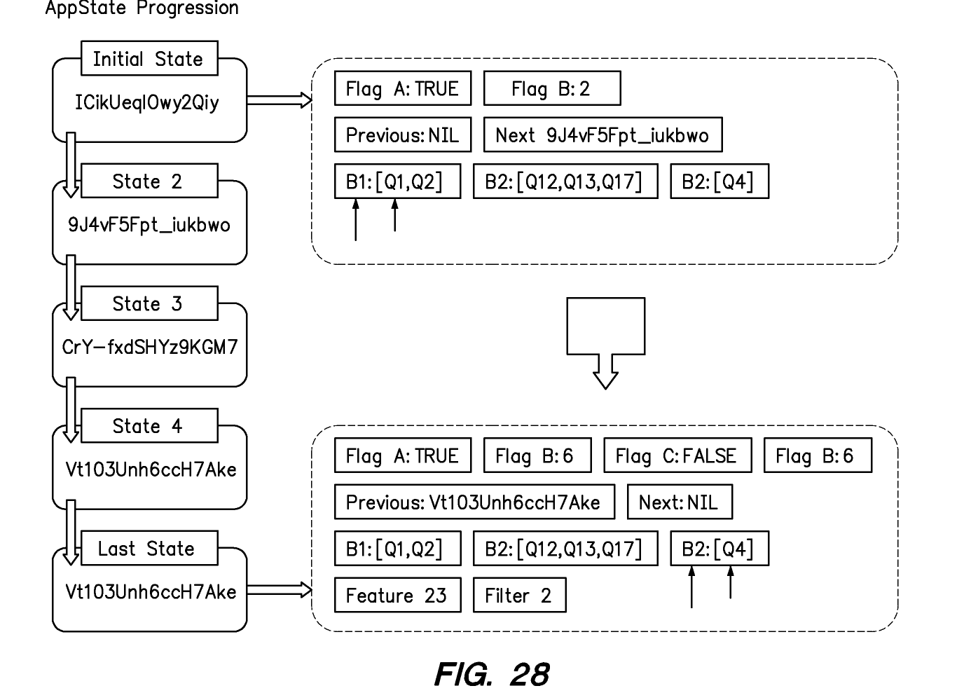

An AppState encapsulates (and stores) all the information of a user's activity while traversing through the questions the user is asked to answer. The different pieces of information that are stored within an AppState are as follows: Previous State Identifier, if any, Next State Identifier, if any, and Flags (and their corresponding values) that have been added to the flag cache as a result of parsing different triggers, filters that might have been included as a result of parsing different triggers (or taken manually), a queue of blocks that have been processed or need to be processed with shifting index pointers, an index of the current block being processed, an index of the question that is under consideration of being displayed within the current block, features that might have been added as a result of parsing triggers, the identifiers of questions that have been already been answered by the user in a chronological sequence, the identifier of the question and the eligible options that had been displayed when the AppState was last visited, the response of the user to the question associated with the current AppState (for faster lookup in case of historical perusal), a set of amplitudes and their corresponding values. The AppState progression is shown is FIG. 28.

The persistent nature of all the AppStates makes their URLs easily shareable amongst team members. This feature can be used as a mechanism to support collaborative decision-making In one embodiment, this may be achieved with Postgresql's HSTORE extension, which allows the data to be stored in key-value format natively. The richness of this data that is stored in each AppState promotes rich data mining. Unlike conventional systems that use surveys, this data is collected while solving a user's problem.

Eligibilities

Whether a question will be displayed is based on its Question Eligibility. If all conditional expressions of an Eligibility pass, the question is displayed; otherwise the next question in the same block is evaluated. If there is no next question in the same block, the first question in the next block is evaluated. If there is no next block, the last question has been answered and the user is prompted to go to the shortlisted products screen.

All options belonging to a question are not shown by default; they go through the same process of an evaluation of their Option Eligibilities. Users are asked the questions and shown response options based on the context set out during the previous flow. In FIG. 29, CMS 2102 permits Option Eligibility to be observed and modified. If the condition for flag 2902 is met, a user can add a question's response option or answer using add button 2904.

### Scoring of Products Based on Context

Feature: Each Container is characterized by a set of capabilities (known as Features) that is representative of the category of product or service to which the Container pertains. These features are manually collated and neatly structured into a logical hierarchy.

Each Feature has a name, description, a key identifier, a parent, a Boolean leaf identifier, a rank with respect to its siblings in the hierarchy and a weight signifying the importance of that feature. A default weight of 5 is attributed for each feature. An example would be a service called Private Clouds, which is a collection of virtualized resources hosted for a single entity or a select group deployed on-premise without the need for an external SaaS provider. The feature identifier is HDEDnw; it is a container feature, parent—hosting and infrastructure options; it is a leaf feature; it has a rankng of 3 with respect to siblings; it has a weight of 3, is not filterable, is not comparable and the feature has never been published.

### Feature Hierarchy, Leaf Features and Product Feature Grid

Features present within a Container are structured into a ranked hierarchy. CMS 2102 permits the hierarchy to be modified. A leaf feature has no children (or sub-feature). Simply put, it is the most granular capability of a Product. Leaf features are useful within the whole scoring architecture.

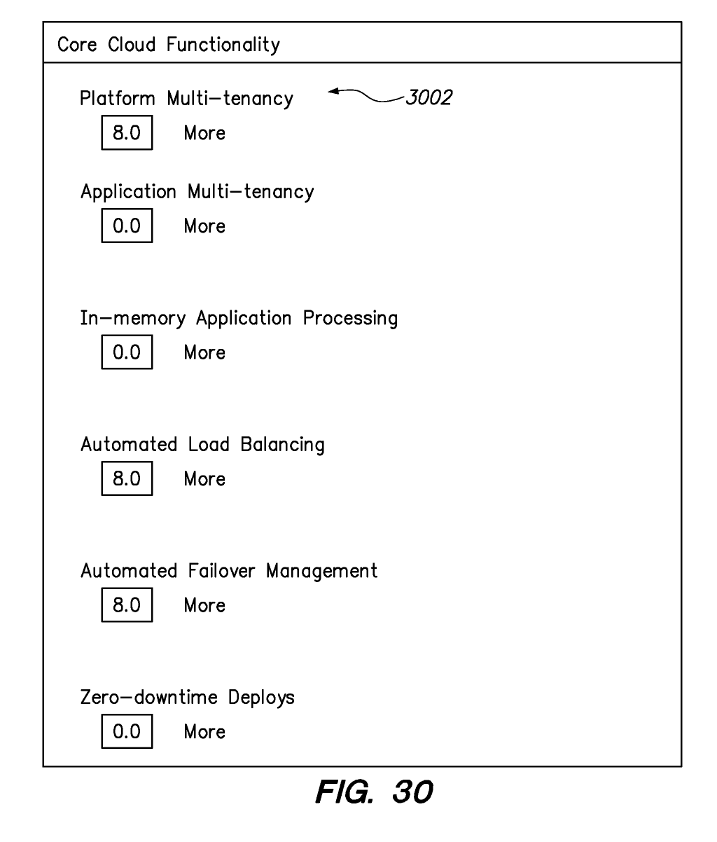

In one embodiment, CMS 2102 includes a Product Feature Grid as shown in FIG. 30 wherein capability values (on a scale of 1 to 8) are manually entered for each product of the Container. This is basically the mapping of what product has what feature. A value of 8 (as shown for Platform Multi-tenancy at 3002 of FIG. 30) is attributed to this mapping if Product A has Feature X to its entirety. A value of 4 is attributed if Product A has Feature Y partially. A value of 0 is attributed if Feature X is missing in Product A.

Absolute Score for a Product

If Container Cᵣ has n leaf features denoted by the set {f₁, f₂, f₃, . . . , fₙ}, then for a Product Pₐ, the absolute score is the summation of all the non-zero feature scores for this product.

$$Absolute Score ( {P}_{a )} = Grid Value of leaf {f}_{1} for {P}_{a} * Weight of {f}_{1} + Grid Value of leaf {f}_{2} for {P}_{a} * Weight of {f}_{2} + Grid Value of leaf {f}_{3} for {P}_{a} * Weight of {f}_{3} … + … + Grid Value of leaf {f}_{n} for {P}_{a} * Weight of {f}_{n}$$

When amplitudes are present (in scenarios where the user is deep down into question parsing), the absolute score is:

$${P}_{a} = Grid Value of leaf {f}_{1} for {P}_{a} * Weight of {f}_{1} * amplitude for {f}_{1} + Grid Value of leaf {f}_{2} for {P}_{a} * Weight of {f}_{2} * amplitude for {f}_{2} + Grid Value of leaf {f}_{3} for {P}_{a} * Weight of {f}_{3} * amplitude for {f}_{3} + … + … + … + Grid Value of leaf {f}_{n} for {P}_{a} * Weight of {f}_{n} * amplitude for {f}_{n} +$$

### Amplitudes and QuestionExitTriggers

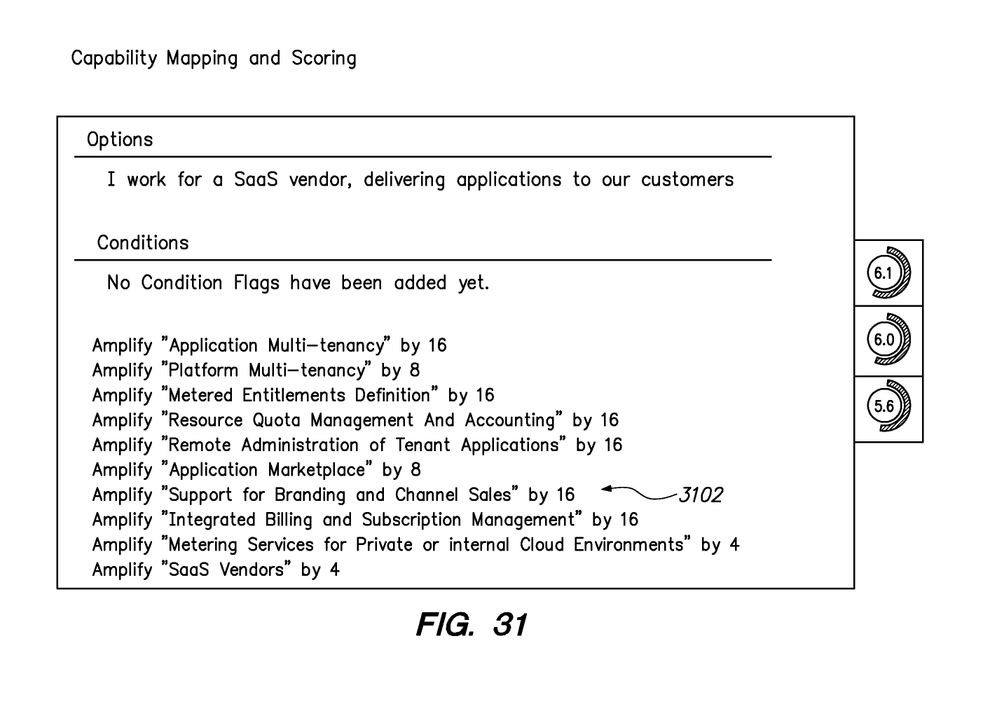

The Queue Processor extracts amplitudes from the previous AppState during the processing of the Block Queue. This is mapped at the QuestionExitTrigger level for the corresponding question and option combination. FIG. 31 shows capability mapping and scoring for the CMS. “Support for Branding and Channel Sales” is amplified by 16, as shown at 3102 of FIG. 31, for example.

### Maximum Score and Relative Score of a Product

The maximum score is calculated as follows:

$$Maximum Score ( {P}_{max} ) = 8 * Weight of {f}_{1} * amplitude for {f}_{1} + 8 * Weight of {f}_{2} * amplitude for {f}_{2} + 8 * Weight of {f}_{3} * amplitude for {f}_{3} + … + 8 * Weight of {f}_{n} * amplitude for {f}_{n}$$

Relative Score of a Product in a scale of 1 to 10 is:

Pᵣ=(Pₐ/Pₘₐₓ)×10

Note that: For the AppState, the set {f₁, f₂, f₃, . . . , fₙ} is not a constant and varies with the number of leaf features in contention at that point. When dimensions come into play, each dimension will have a certain number of features mapped to it, and the score for that Dimension is obtained using the same formula. Only the feature set changes to: {fᵢ, . . . , fⱼ}.

$${P}_{a} = Grid Value of leaf {f}_{1} for {P}_{a} * Weight of {f}_{1} * amplitude for {f}_{1} + Grid Value of leaf {f}_{2} for {P}_{a} * Weight of {f}_{2} * amplitude for {f}_{2} + Grid Value of leaf {f}_{3} for {P}_{a} * Weight of {f}_{3} * amplitude for {f}_{3} + … + Grid Value of leaf {f}_{n} for {P}_{a} * Weight of {f}_{n} * amplitude for {f}_{n}$$

Social sentiment is an indication of how well a product or a vendor is perceived in the market. The process of computing social sentiment can be broken into three different steps: aggregation of raw information, analyzing sentiment, and normalizing the data to come up with the final score. A fourth step—creating training data sets—happens in parallel.

The raw information comes from a variety of sources including Twitter™, Quora™, Google Play Store, iTunes™, Amazon™, Salesforce™, and AppExchange™. Some information also comes from specialized sources such as Software Informer™ (for conferencing tools) or Intuit Marketplace™ (for financial and accounting software).

Structured channels such as Twitter™, LinkedIn™ and Facebook™ offer searchable APIs to extract the data while automated scrapers are written to extract data from all app stores like sources (web and mobile).

Once the raw data is aggregated, ratings are combined into a standard scale of 0 to 10, and text is parsed through the sentiment analytics module, outputting a score on the same scale. The ratings for source, volume, and relevance are then normalized based on the principle that volume is a better indicator of overall trustworthiness of the sentiment.

The normalization is done so that a product with only 2 ratings, both 4-star, is not rated on par with a product with a higher number of ratings that average out at 4 stars (for example, 10 ratings, 8 4-star, a 5-star and a 1-star). A logarithmic production function is used to normalize this. Also in the works are source normalization and relevance normalization methods, both collecting data before going live.

User Actions: UserShortlistAppAction is an entity that stores all the user actions making the AppState+any activity by the user completely persistent. This implies for a particular AppState URL like https://Credii.com/select/Platform-as-a-Service-Clouds/ICikUeq1Owy2QiY_—where the key “ICikUeq1Owy2QiY_,” denotes the AppState—is a database persistent URL and can be revisited later by the user. If a user has shortlisted a product by clicking the “Add to Shortlist” button, this action will be persisted so that back-end continuity is maintained across AppStates. The user can go backwards and forwards without losing the user's state.

The components of UserShortlistAppAction are as follows: A foreign key identifier to identify the ShortlistApp, a list of filters that have been taken by the user, a list of questions that have been skipped by the user, the latest two dimensions in contention, the view of the result set (Graph or List), a list of products shortlisted by the user, a list of products requested by the user to be added to the initial set of products, and/or a list of filters requested by the user to be added to the initial set of filter.

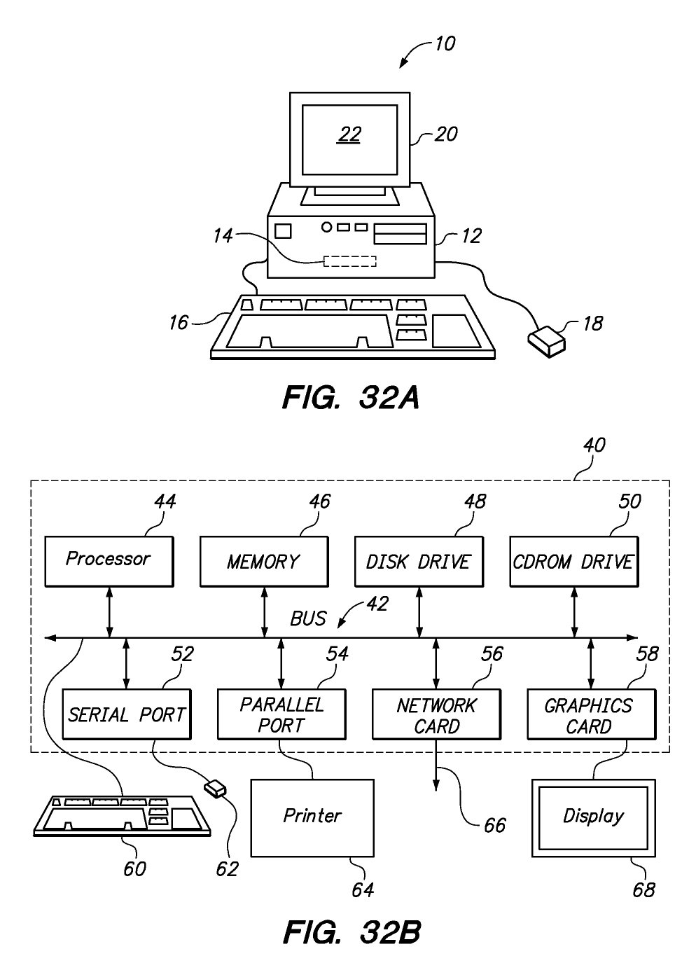

FIG. 32A shows a typical computer 10 such as would be operated by a user /party on the Internet. Computer 10 includes computer components such as a processor, memory, drive. User input devices include keyboard 16 and mouse 18. Output devices include display 20 having a display screen 22. Naturally, many other configurations of a computer system are possible. Some computer systems may have additional components to those shown in FIG. 32A while others will have fewer components. For example, server computers need not have attached input and output devices since they may only be accessed from time to time by other computers over a network. Human interaction with such a server computer can be at another computer that is equipped with input and output devices. Input and output devices exist in many variations from those shown in FIG. 32A. Displays can be LCDs, monitors, etc. Input devices can include touch screens, microphones, etc. In general, use of the term “input device” is intended to include all possible types of devices and ways to input information into a computer system or onto a network. Likewise the term “output device” includes all possible types of devices and ways to output information from a computer system to a human or to another machine.

The computer itself can be of varying types including mobile devices, notepads, etc. The computer may not resemble the computer of FIG. 32A as in the case where a processor is embedded into another device. Because of the ever-changing nature of computers and networks, the description of hardware in this specification is intended only by way of example for the purpose of illustrating the preferred embodiment. Any distributed networked system capable of executing programmed instructions is suitable for use with the present invention.

FIG. 32B shows subsystems of the computer of FIG. 32A. In FIG. 32B, subsystems within box 40 are internal. Bus 42 is used to transfer information in the form of digital data between processor 44, memory 46, drive 48, drive 50, serial port 52, parallel port 54, network card 56 and graphics card 58. Many other subsystems may be included in an arbitrary computer system and some of the subsystems shown in FIG. 32B may be omitted. External devices can connect to the computer system's bus (or another bus or line, not shown) to exchange information with the subsystems in box 40. For example, devices such as keyboard 60 can communicate with processor 44 via dedicated ports and drivers (shown symbolically as a direct connection to bus 42). Mouse 62 is connected to serial port 52. Devices such as printer 64 can connect through parallel port 54. Network card 56 can connect the computer system to a network. Display 68 is updated via graphics card 58. Again, many configurations of subsystems and external devices are possible.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. Functions can be performed in hardware, software, or a combination of both. Unless otherwise stated, functions may also be performed manually, in whole or in part. In the description herein, numerous specific details are provided, such as examples of components and/or methods, to provide a thorough understanding of particular embodiments. One skilled in the relevant art will recognize, however, that a particular embodiment can be practiced without one or more of the specific details, or with other apparatus, systems, assemblies, methods, components, materials, parts, and/or the like. In other instances, well-known structures, materials, or operations are not specifically shown or described in detail to avoid obscuring aspects of particular embodiments.

A “computer-readable medium” for purposes of particular embodiments may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory.

Particular embodiments can be implemented in the form of control logic in software or hardware or a combination of both. The control logic, when executed by one or more processors, may be operable to perform that what is described in particular embodiments.

A “processor” or “process” includes any human, hardware and/or software system, mechanism or component that processes data, signals, or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, “a specific embodiment”, or “particular embodiment” means that a particular feature, structure, or characteristic described in connection with the particular embodiment is included in at least one embodiment and not necessarily in all particular embodiments. Thus, respective appearances of the phrases “in a particular embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other particular embodiments. It is to be understood that other variations and modifications of the particular embodiments described and illustrated herein are possible in light of the teachings herein and are to be considered as part of the spirit and scope.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an” and “the” includes plural references unless the context clearly dictates otherwise. Also, as used in the description herein and throughout the claims that follow, the meaning of “in” includes “in” and “on” unless the context clearly dictates otherwise.

While the above is a complete description of exemplary specific embodiments of the invention, additional embodiments are also possible. Thus, the above description should not be taken as limiting the scope of the invention, which is defined by the appended claims along with their full scope of equivalents.

We claim:

1. A guided and interactive method for determining which product or service to select from a plurality of available products and services, the method comprising:
by one or more computing systems, storing in a database a plurality of product and service profiles, the corresponding products and services configured for recommendation to a user and for each product or service profile, storing therein a plurality of in-depth features or attributes for the product or service associated with said profile;
by the one or more computing systems, receiving a user profile for storage in said database wherein said user profile includes personal user information including at least an industry role of the user that is seeking a recommendation for a product or service;
by the one or more computing systems, receiving a user selection input signal indicating a type of product or service that the user is seeking a recommendation for;
by the one or more computing systems, computing for display to the user, an initial ranking for the products or services wherein the initial ranking is based at least in part on a vector having at least two dimensions and at least in part on the plurality of product and service profiles and at least in part on the user profile;
by the one or more computing systems, generating a real-time queue configured to receive a plurality of blocks including an initial block and a second or subsequent blocks, each of said plurality of blocks being configured to include a plurality of related questions for display to the user;
by the one or more computing systems, determining the initial block to be generated and moved into the real-time queue wherein said determination is based in part on at least the user profile or on at least a flag that sets a condition for moving the initial block into the queue, said initial block including a plurality of questions including at least a first question and a second question that are related wherein despite being in the initial block, said first and second questions may not be displayed to the user;
by the one or more computing systems traversing the initial block to determine whether all of the questions including the first question and the second question will be displayed wherein said determination is based in part on at least the user profile and at least in part on a flag variable setting a condition for displaying the first question and the second question;
by the one or more computing systems wherein if the condition for displaying the first question fails, the first question is skipped and not displayed;
by the one or more computing systems wherein if the first question from the initial block is displayed, determining a plurality of response options that are to be displayed for selection by the user responsive to the first question wherein said determination is based at least in part on a mapping of said plurality of response options to the first question and on at least a flag variable setting a condition for the eligibility of the response options for display;
by the one or more computing systems receiving a user input indication selecting one or more response options from the plurality of response options for the first question;
by the one or more computing systems generating for display a recomputed ranking for the products or services wherein the ranking of products and services previously ranked lower may be amplified or ranking of products and services previously ranked higher may be lowered wherein the recomputed ranking is based at least in part on the one or more response options selected for the first question and at least in part on said vector having at least two dimensions;
by the one or more computing systems determining whether to display the second and subsequent questions from the initial bloc, wherein said determination is based in part on at least a flag setting a condition for displaying the second and respective subsequent questions, said second question if displayed being sequential and occurring after the one or more responses for the first question are selected, said subsequent questions, if displayed, being sequential and occurring after one or more responses for the preceding question are selected;
by the one or more computing systems, if the second question from the initial block is displayed, determining a plurality of response options that are to be displayed for selection by the user responsive to the second question wherein said determination is based at least in part on a mapping of said plurality of response options to the second question or at least in part on; and on at least a flag variable setting a condition for the eligibility of the response options for display for the second question.

2. The method of claim 1 further comprising
if the second question from the initial block is not displayed, determining whether a third or subsequent question is present in the initial block; and
processing the third or subsequent question, if present in the initial block, to determine whether said question is eligible for display.

3. The method of claim 1 further comprising
by the one or more computing systems, determining whether to generate and move a second block into the real-time queue wherein said determination is based in part on a response options for the first or the second question selected by the user, said second block including a plurality of questions including at least a third question and a fourth question that are related wherein despite being in the second block, said third and fourth questions may not be displayed to the user.

4. The method of claim 1 further comprising
by the one or more computing systems, determining upon displaying a last eligible question in the initial block whether the second block exists in the initial queue; and if so,
by the one or more computing systems, traversing the second block to determine whether all of the questions in the second block including a third question and a fourth question will be displayed wherein said determination is based in part on at least the user profile and at least in part on a flag variable setting a condition for displaying the third question and the fourth question.

5. The method of claim 1 wherein the first dimension is social sentiment.

6. The method of claim 1 wherein the second dimension is product capability function.

7. The method of claim 1 wherein upon selection of one or more response options for the first question, adding additional products or services to the products and services used for the recomputed rankings

8. The method of claim 1 further wherein upon selection of one or more response options for the first question, amplifying either upwards or downwards the value of a product or service attributes that will affect scoring and the ranking of products and services.

9. A computer program product including a non-transitory computer readable storage medium having executable code, the code when executed by a processor to be adapted for performing the following:
storing in a database a plurality of product and service profiles, the corresponding products and services configured for recommendation to a user, and for each product or service profile, storing therein a plurality of in-depth features or attributes for the product or service associated with said profile;
receiving a user profile for storage in said database wherein said user profile includes personal user information including at least an industry role of the user that is seeking a recommendation for a product or service;
receiving a user selection input signal indicating a type of product or service that the user is seeking a recommendation for;
generating for display to the user an initial ranking for the products or services wherein the initial ranking is based at least in part on a vector having at least two dimensions and at least in part on the plurality of product and service profiles and at least in part on the user profile;
generating a real-time queue configured to receive a plurality of blocks including an initial block and a second or subsequent block, each of said plurality of blocks being configured to include a plurality of related questions for display to the user;
generating and moving the initial block into the real-time queue wherein said generation is based in part on at least the user profile or on at least a flag that sets a condition for moving the initial block into the queue, said initial block including a plurality of questions including at least a first question and a second question wherein despite being in the initial block, said first and second questions may not be displayed to the user;
traversing the initial block to determine whether all of the questions including the first question and the second question will be displayed wherein said determination is based in part on at least the user profile and at least in part on a flag variable setting a condition for displaying the first question and the second question;
if the condition for displaying the first question fails, skipping and not displaying the first question;
if the first question from the initial block is displayed, determining a plurality of response options that are to be displayed for selection by the user responsive to the first question wherein said determination is based at least in part on a mapping of said plurality of response options to the first question and on at least a flag variable setting a condition for the eligibility of the response options for display;
receiving a user input indication selecting one or more response options from the plurality of response options for the first question;
generating for display a recomputed ranking for the products or services wherein the ranking of products and services previously ranked lower may be amplified or ranking of products and services previously ranked higher may be lowered wherein the recomputed ranking is based at least in part on the one or more response options selected for the first question and at least in part on said vector having at least two dimensions;
determining whether to display the second and subsequent questions from the initial block wherein said determination is based in part on at least a flag setting a condition for displaying the second and respective subsequent questions, said second question if displayed being sequential and occurring after the one or more responses for the first question are selected, said subsequent questions, if displayed, being sequential and occurring after one or more responses for the preceding question are selected;
if the second question from the initial block is displayed, determining a plurality of response options that are to be displayed for selection by the user responsive to the second question wherein said determination is based at least in part on a mapping of said plurality of response options to the second question or at least in part on; and on at least a flag variable setting a condition for the eligibility of the response options for display for the second question.

10. The computer program product of claim 9 further comprising
if the second question from the initial block is not displayed, determining whether a third or subsequent question is present in the initial block; and
processing the third or subsequent question if present in the initial block to determine whether said question is eligible for display.

11. The computer program product of claim 9 further comprising
determining whether to generate and move a second block into the real-time queue wherein said determination is based in part on response options for the first or the second question selected by the user, said second block including a plurality of questions including at least a third question and a fourth question that are related wherein despite being in the second block, said third and fourth questions may not be displayed to the user.

12. The computer program product of claim 9 further comprising
determining, upon displaying a last eligible question in the initial block whether the second block exists in the initial queue; and if so,
traversing the second block to determine whether all of the questions in the second block including a third question and a fourth question will be displayed wherein said determination is based in part on at least the user profile and at least in part on a flag variable setting a condition for displaying the third question and the fourth question.

13. The computer program product of claim 9 wherein the first dimension is social sentiment.

14. The computer program product of claim 9 wherein the second dimension is product capability function.

15. The computer program product of claim 9 wherein upon selection of one or more response options for the first question, adding additional products or services to the products and services used for the recomputed rankings

16. The computer program product of claim 9 wherein upon selection of one or more response options for the first question, amplifying either upwards or downwards, the value of product or service attributes that will affect scoring and the ranking of products and services.
